(19) United States
(12) Patent Application Publication
(10) Pub. No.: US 2026/0161105 A1
(43) Pub. Date: Jun. 11, 2026

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: TAICHI SATO, Shizuoka (JP); SHUNTARO WATANABE, Kanagawa (JP); MASATADA HIROTA, Shizuoka (JP); NAO HIGUCHI, Shizuoka (JP); KENTARO TANAKA, Shizuoka (JP); TSUTOMU NISHIDA, Shizuoka (JP); TOMOHITO ISHIDA, Shizuoka (JP)

(21) Appl. No.: 19/180,727

(22) Filed: Apr. 16, 2025

Related U.S. Application Data
(63) Continuation of application No. PCT/JP2023/036715, filed on Oct. 10, 2023.

(30) Foreign Application Priority Data
Oct. 19, 2022 (JP) 2022-167792
Apr. 26, 2023 (JP) 2023-072657

(51) Int. Cl. G03G 5/147

(52) U.S. Cl. CPC G03G 5/14704; G03G 5/14734

(57) ABSTRACT

An electrophotographic photosensitive member allowing for favorable transfer performance. This electrophotographic photoreceptor has a surface layer including a binder resin and a particle, the particle being an organic-inorganic composite particle, the organic-inorganic composite particle including a resin particle and an inorganic microparticle partially embedded in the resin particle, wherein a surface of the organic-inorganic composite particle has a small convexity A derived from the inorganic microparticle, a surface of the surface layer has large convexities derived from the organic-inorganic composite particle, the large convexity has a height of 70 nm or more and 250 nm or less, a surface of the large convexity has a small convexity B derived from the small convexity A, and the small convexity B has a curvature radius of 10 nm or more and 30 nm or less.

### CROSS-REFERENCE TO RELATED APPLICATIONS

This application is a Continuation of International Patent Application No. PCT/JP2023/036715, filed Oct. 10, 2023, which claims the benefit of Japanese Patent Application No. 2022-167792, filed Oct. 19, 2022, and Japanese Patent Application No. 2023-072657, filed Apr. 26, 2023, all of which are hereby incorporated by reference herein in their entirety.

### BACKGROUND OF THE INVENTION

### Field of the Invention

The present invention relates to an electrophotographic photosensitive member, a process cartridge having the electrophotographic photosensitive member, and an electrophotographic apparatus.

### Description of the Related Art

Recently, in the field of electrophotographic apparatuses such as copiers and printers, high-speed printing is required to increase the productivity of electrophotographic apparatuses. In order to achieve high speed in an electrophotographic apparatus, it is necessary to repeat the charging, exposure, developing, and transfer steps of the electrophotographic process, where a latent image created in the exposure step is developed with toner in the developing step, and the toner is efficiently transferred to a medium such as paper or an intermediate transfer medium in the transfer step.

In the transfer step, a predetermined bias is applied to the toner in order to transfer, to the recording medium, the toner with which the latent image is developed on the electrophotographic photosensitive member. The applied bias can be reduced by adding an external additive to the toner and creating an uneven profile on the surface of the electrophotographic photosensitive member to reduce the adhesion between the toner and the surface of the electrophotographic photosensitive member. This not only can save space, in the electrophotographic apparatus, for a high-voltage power supply to apply a high bias, but also can suppress toner scattering due to the high transfer bias, and thus can improve image quality. As one method to reduce the adhesion of toner onto the surface of an electrophotographic photosensitive member, it has been conventionally proposed to form a convex shape on the surface of the electrophotographic photosensitive member by including particles on the surface of the electrophotographic photosensitive member to make the contact between the toner and the surface of the electrophotographic photosensitive member a point contact.

In Japanese Patent Application Laid-Open No. 2020-71423, regardless of the amount of lubricant supplied, in order to improve cleaning performance and reduce wear of an electrophotographic photosensitive member and cleaning blades, an electrophotographic photosensitive member is disclosed that has a convex structure on the surface of the outermost layer including a cured product obtained by polymerizing a composition containing a polymerizable monomer and an inorganic filler.

In order to achieve both wear resistance and lubricity in an electrophotographic photosensitive member, Japanese Patent Application Laid-Open No. 2019-45862 discloses an electrophotographic photosensitive member having the surface layer obtained by curing a coating film containing organic resin particles, namely at least one of acrylic resin particles or melamine resin particles, and a hole-transporting substance having a polymerizable functional group.

In order to reduce image irregularities caused by uneven luster of a support while maintaining wear resistance, Japanese Patent Application Laid-Open No. 2016-118628 discloses an electrophotographic photosensitive member with the surface of the surface layer having an uneven shape formed by mechanical polishing and containing a curable resin and polytetrafluoroethylene particles.

In order to improve cleaning performance and lubricity of the surface of an electrophotographic photosensitive member, Japanese Patent Application Laid-Open No. 2013-029812 discloses an electrophotographic photosensitive member containing encapsulated spherical particles that are embedded in pores of a matrix component.

In order to maintain the mold-releasing effect, Japanese Patent Application Laid-Open No. 2009-14915 discloses an electrophotographic photosensitive member in which independent concave portions with a depth of 0.1 μm or more and 10 μm or less are formed on the surface of the surface layer of the electrophotographic photosensitive member, and a mold-releasing material is contained within the concave portions.

In order to improve both wear resistance of an electrophotographic photosensitive member and chipping of cleaning blades, Japanese Patent Application Laid-Open No. 2022-16937 discloses an electrophotographic photosensitive member in which organic-inorganic composite particles are contained in the surface layer of the electrophotographic photosensitive member.

In recent years, electrophotographic apparatuses require both a more efficient transfer step for reducing waste toner in response to environmental concerns and higher image quality at higher output speeds. To improve transfer performance, it is effective to reduce the contact area between toner and an electrophotographic photosensitive member. As a unit to achieve this, the above-mentioned Japanese Patent Application Laid-Open No. 2020-71423, Japanese Patent Application Laid-Open No. 2019-45862, Japanese Patent Application Laid-Open No. 2016-118628, Japanese Patent Application Laid-Open No. 2013-029812 as well as Japanese Patent Application Laid-Open No. 2009-14915 and Japanese Patent Application Laid-Open No. 2022-16937 disclose the technology of adding particles to the surface of an electrophotographic photosensitive member. However, in Japanese Patent Application Laid-Open No. 2020-71423, Japanese Patent Application Laid-Open No. 2019-45862, and Japanese Patent Application Laid-Open No. 2016-118628, it is difficult to expose and align particles evenly on the surface of the electrophotographic photosensitive member, and there are issues with the arrangement of particles that contribute to transfer. FIG. 2 (see signs in FIG. 1) shows an image of the arrangement of particles present on the surface of an electrophotographic photosensitive member described in Japanese Patent Application Laid-Open No. 2020-71423, Japanese Patent Application Laid-Open No. 2019-45862, and Japanese Patent Application Laid-Open No. 2016-118628.

Further, in Japanese Patent Application Laid-Open No. 2013-029812, when there is a difference in peripheral speed between an electrophotographic photosensitive member and an intermediate transfer medium or a recording medium in the transfer step, the encapsulated spherical particles move. Thus, a phenomenon was observed where the contact area between the toner and the surface of the electrophotographic photosensitive member increased and transfer performance decreased. In addition, in Japanese Patent Application Laid-Open No. 2009-14915, multiple release materials were contained in the concave portions, and the point contact between the toner and the surface of the electrophotographic photosensitive member could not be maintained. It has been found that this makes it difficult to maintain good transfer performance for a long period of time. In Japanese Patent Application Laid-Open No. 2022-16937, it has been found that the height of convex formed on the surface of the electrophotographic photosensitive member was not high enough to ensure sufficient transfer performance.

### SUMMARY OF THE INVENTION

Therefore, the purpose of the present invention is to provide an electrophotographic photosensitive member with better transfer performance than the above-mentioned technologies.

The above objectives are achieved by the following item of the present invention. That is, the present invention is characterized by an electrophotographic photosensitive member having a surface layer including a binder resin and a particle, the particle being an organic-inorganic composite particle, the organic-inorganic composite particle including a resin particle and an inorganic microparticle partially embedded in the resin particle, wherein a surface of the organic-inorganic composite particle has a small convexity A derived from the inorganic microparticle, a surface of the surface layer has a large convexity derived from the organic-inorganic composite particle, the large convexity has a height of 70 nm or more and 250 nm or less, a surface of the large convexity has a small convexity B derived from the small convexity A, and the small convexity B has a curvature radius of 10 nm or more and 30 nm or less.

In addition, the present invention provides a process cartridge integrally supporting the above electrophotographic photosensitive member and at least one unit selected from the group consisting of charging units, developing units, and cleaning units, and being detachable from a main body of an electrophotographic apparatus.

Further, the present invention provides an electrophotographic apparatus including the above electrophotographic photosensitive member and a charging unit, an exposure unit, a developing unit, and a transfer unit.

Further features of the present invention will become apparent from the following description of exemplary embodiments with reference to the attached drawings.

### BRIEF DESCRIPTION OF THE DRAWINGS

FIG. 1 shows an example of the layer structure of an electrophotographic photosensitive member according to the present invention.

FIG. 2 is a conceptual diagram of each layer structure in a cross section of a conventional electrophotographic photosensitive member.

FIG. 3 shows a schematic diagram of an organic-inorganic composite particle used in the present invention.

FIG. 4A is a conceptual diagram of a large convexity formed by the organic-inorganic composite particle.

FIG. 4B is a conceptual diagram of a large convexity formed by the organic-inorganic composite particle.

FIG. 5 is a diagram showing an example of a schematic configuration of an electrophotographic apparatus with a process cartridge equipped with an electrophotographic photosensitive member of the present invention.

FIG. 6 is a diagram illustrating a method of measuring the height of a small convexity A of an organic-inorganic composite particle.

FIG. 7 is a diagram illustrating a method of measuring the height of a large convexity.

FIG. 8 is a diagram illustrating a method of measuring the height of a small convexity B.

FIG. 9 is a diagram illustrating a method of measuring the curvature radius of a small convexity B.

### DESCRIPTION OF THE EMBODIMENTS

Hereinafter, preferable Embodiments of the present invention will be described.

### [Electrophotographic Photosensitive Member]

An electrophotographic photosensitive member of the present invention is characterized by having a surface layer.

Here, the surface layer refers to a layer located at the outermost surface in the photosensitive member, and means a layer in contact with a charging member or toner.

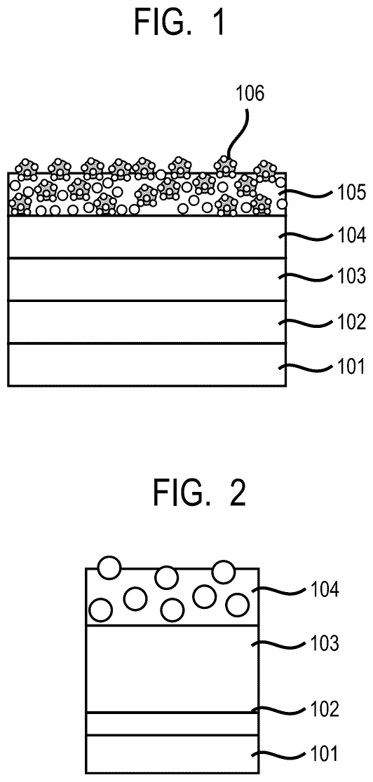

FIG. 1 is a diagram showing an example of the layer structure of the electrophotographic photosensitive member. FIG. 1 shows a support 101, an undercoat layer 102, a charge generation layer 103, and a charge transport layer 104. There are a surface layer 105 in the present invention and an organic-inorganic composite particle 106 in the present invention.

In addition, the electrophotographic photosensitive member of the present invention may also be shaped like a belt or a sheet.

The electrophotographic photosensitive member of the present invention is used in an image forming method including: a charging step of electrically charging a surface of the electrophotographic photosensitive member; an exposure step of exposing the electrically charged electrophotographic photosensitive member to form an electrostatic latent image; a developing step of supplying toner to the electrophotographic photosensitive member having the electrostatic latent image to form a toner image; and a transfer step of transferring the toner image formed on the electrophotographic photosensitive member.

Examples of the method for producing an electrophotographic photosensitive member of the present invention include a method in which a coating liquid for each layer described later is prepared, applied in the desired layer order, and dried. Examples of the method of applying a coating liquid at this time include dip coating, spray coating, inkjet coating, roll coating, die coating, blade coating, curtain coating, wire bar coating, or ring coating. Among these, dip coating is preferred from the viewpoint of efficiency and productivity.

Hereinbelow, each layer will be described.

### Surface Layer

The present inventors have examined and found that it is necessary to satisfy the following requirements:
the surface layer includes a binder resin and a particle,
the particle being an organic-inorganic composite particle,
the organic-inorganic composite particle including
a resin particle and
an inorganic microparticle partially embedded in the resin particle, wherein
a surface of the organic-inorganic composite particle has a small convexity A derived from the inorganic microparticle,
a surface of the surface layer has a large convexity derived from the organic-inorganic composite particle,
the large convexity has a height of 70 nm or more and 250 nm or less,
a surface of the large convexity has a small convexity B derived from the small convexity A, and
the small convexity B has a curvature radius of 10 nm or more and 30 nm or less.

Why the effects of the present invention can be exerted under the above conditions is not explicitly clear. However, the present inventors' speculation is as follows.

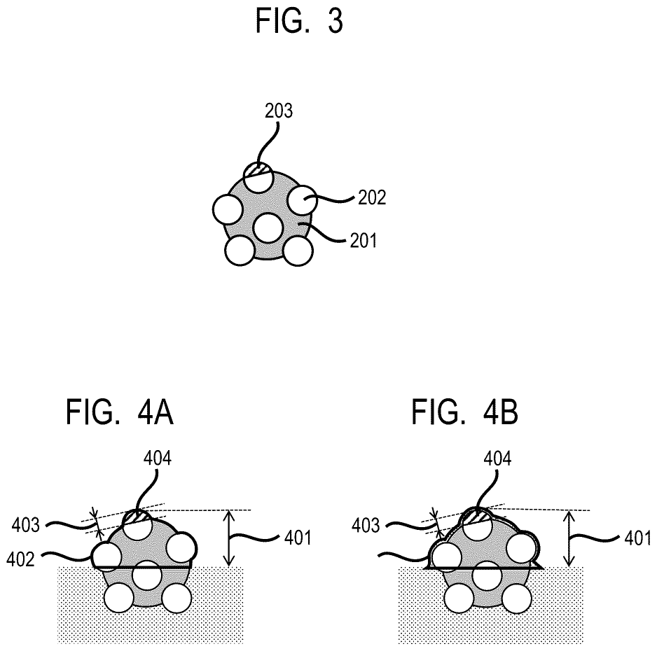

FIG. 3 shows a schematic diagram of an organic-inorganic composite particle used in the present invention. The details of the reason are described below, but the organic-inorganic composite particle has to have a resin particle 201 and inorganic microparticles 202 partially embedded in the resin particle 201, and a small convexity A203 derived from the inorganic microparticle should be present on a surface of the organic-inorganic composite particle.

The organic-inorganic composite particles used in the present invention can be produced by the method described in the Examples of International Publication No. WO2013/063291, although the specific production method is described later.

In order to improve transfer performance in an electrophotographic image forming apparatus, it is necessary to reduce adhesion between toner and an electrophotographic photosensitive member. The strength of adhesion between the toner and the electrophotographic photosensitive member is roughly classified into electrostatic and non-electrostatic adhesion strengths.

Since the electrostatic adhesion strength is mainly determined by image force, the strength is strongly affected by the amount of toner charge. The magnitude of the image force is proportional to the amount of toner charge and inversely proportional to the square of the distance from the surface of the electrophotographic photosensitive member, which is an adhesion target, and the amount of toner charge. Therefore, large convexities due to organic-inorganic composite particles are required on the surface of the electrophotographic photosensitive member. The large convexities allow for the distance between the electrophotographic photosensitive member and the toner, which reduces the image force and improves the transfer performance. A method to increase the height of each large convexity may be to increase the particle diameter of each organic-inorganic composite particle or to increase the proportion of the organic-inorganic composite particles in the film so as to push the particles to the top.

The height of each large convexity should be 70 nm or more and 250 nm or less. If the height is less than 70 nm, the distance between the electrophotographic photosensitive member and the toner is not sufficient, and the electrostatic adhesion is not sufficiently suppressed. If the height exceeds 250 nm, the organic-inorganic composite particles tend to detach, and transfer performance decreases with use.

To improve the transfer performance, it is necessary to decrease the above-mentioned non-electrostatic adhesion strength and also van der Waals force. To reduce van der Waals force, it is effective to mechanically decrease the contact area between the toner and the electrophotographic photosensitive member. Therefore, the large convexity in contact with the toner should have a small convexity B with a small curvature radius. In other words, the presence of large convexities with a large height enables the distance between the electrophotographic photosensitive member and the toner to be increased while reducing the electrostatic adhesion strength. The presence of small convexity B on the large convexity limits the contact area between the toner and the electrophotographic photosensitive member, so that the non-electrostatic adhesion strength can also be suppressed. The small convexity B should have a curvature radius of 10 nm or more and 30 nm or less. If the curvature radius is below 10 nm, the toner comes into contact with not only the small convexity B but also the large convexity, and as a result, the contact area cannot be reduced. If the curvature radius exceeds 30 nm, the area of portion in contact with the toner cannot be sufficiently small.

In order to form a small convexity B on a surface of the electrophotographic photosensitive member, the organic-inorganic composite particle should have a resin particle and inorganic microparticles partially embedded in the resin particle, and a surface of the organic-inorganic composite particle should have a small convexity A derived from the inorganic microparticle. FIGS. 4A and 4B show schematic diagrams of the shapes of a large convexity 402 (area surrounded by thick lines) and a small convexity B404 formed on a surface of an organic-inorganic composite particle of an electrophotographic photosensitive member. FIG. 4A shows that when the organic-inorganic composite particle is exposed from a surface of the electrophotographic photosensitive member (small convexity B404), the small convexity A203 and the small convexity B404 are the same. On the other hand, when the organic-inorganic composite particle is covered by a binder resin of the surface layer, as shown in FIG. 4B, the small convexity A203 is part of the small convexity B404. Thus, the small convexity A203 is different from the small convexity B404.

The case is preferred where the height 403 of the small convexity B is 10 nm or more and 40 nm or less. If the height is below 10 nm, the toner comes into contact with not only the small convexity B but also the large convexity, and as a result, the contact area cannot be reduced. If the height exceeds 40 nm, the area of contact between the toner and the small convexity B cannot be sufficiently small.

In addition, the case is preferred where the height 401 of the large convexity is 3.0 times or more and 10.0 times or less the curvature radius of the small convexity B. If the height is less than 3.0 times, the organic-inorganic composite particles are likely to detach, and transfer performance decreases with use. If the height exceeds 10.0 times, the distance between the electrophotographic photosensitive member and the toner is not sufficient, and the electrostatic adhesion strength may not be sufficiently suppressed.

In addition, the small convexity B is preferably exposed from the surface layer. This is because the exposed inorganic particles with high hardness easily make point contact with the toner, keeping the contact area small and suppressing the non-electrostatic adhesion strength.

The number-average primary particle diameter of organic-inorganic composite particles should be 100 nm or more and 400 nm or less. If the diameter is below 100 nm, the height of the large convexity cannot be maintained sufficiently, and the distance between the toner and the electrophotographic photosensitive member becomes too close, so that the electrostatic adhesion strength cannot be sufficiently suppressed. If the diameter exceeds 400 nm, the number of contact points between the toner and the electrophotographic photosensitive member increases, and the non-electrostatic adhesion strength cannot be sufficiently suppressed. More preferred is 100 nm or more and 250 nm or less.

In addition, the case is preferred where the shape factor SF-2 of the organic-inorganic composite particle is 103 or more and 120 or less. If the shape factor is less than 103, it tends to be difficult to achieve favorable electrostatic adhesion with the toner, and if the shape factor is more than 120, contact with the toner tends to occur easily and the electrostatic adhesion strength is not sufficiently suppressed.

The surface layer of the electrophotographic photosensitive member of the present invention can suppress the release of the organic-inorganic composite particles and can also decrease the number of large convexities caused by the organic-inorganic composite particles, resulting in a smaller area of contact with the toner. Therefore, it is preferable to add a second particle. Several kinds of particles may be included as the second particle.

The particle diameter of the second particle should be ⅕ or more and ½ or less of the particle diameter of the organic-inorganic composite particle. When the particle diameter of the second particle is smaller than ⅕, the release prevention effect of the organic-inorganic composite particle cannot be sufficiently elicited, and the transfer performance improving effect disappears with use. When the particle diameter is larger than ½, the second particle comes into contact with the toner, and the transfer performance improving effect is suppressed.

The ratio between the organic-inorganic composite particle and the second particle, namely the value of organic-inorganic composite particle/second particle is preferably 5 vol % or more and 90 vol % or less. When the value of organic-inorganic composite particle/second particle is less than 5 vol %, the toner and second particle begin to contact each other, and the transfer performance improving effect is suppressed. If the value exceeds 90 vol %, the number of large convexities caused by the organic-inorganic composite particles increases, resulting in an increase in the number of points in contact with the toner, which limits the transfer performance improving effect.

When the area occupied by the organic-inorganic composite particles and the second particles on the surface of the surface layer of the electrophotographic photosensitive member of the present invention is S1 and the area occupied by materials other than the organic-inorganic composite particles and the second particles is S2, S1/(S1+S2) is preferably 0.70 or more and 1.00 or less. When S1/(S1+S2) is less than 0.70, the particle-free area should not have any convexity. In the present invention, a scanning electron microscope (SEM) is used to observe the surface of the surface layer of the electrophotographic photosensitive member of the present invention from the top surface under settings at an acceleration voltage of 5 kV or higher. The area of the electron reflection image of the surface layer if the particle image is detected is added to the area S1 of the particles.

Theoretically, the upper bound of S1/(S1+S2) is 1.00. S1/(S1+S2) is more preferably 0.80 or more and 1.00 or less, and still more preferably 0.85 or more and 0.95 or less.

The case is preferred where the proportion of the organic-inorganic composite particles and particles other than the organic-inorganic composite particles to the total volume of the surface layer is 33 vol % or more and 70 vol % or less. When the proportion of the organic-inorganic composite particles and particles other than the organic-inorganic composite particles as contained in the film is less than 33 vol %, the height of each large convexity becomes insufficient, the electrostatic adhesion strength cannot be suppressed, and the small convexity B is unlikely to be exposed from the resin of the surface layer. If the contact area exceeds 70 vol %, the organic-inorganic composite particles detach with use. Therefore, preferred is 33 vol % or more and 70 vol % or less. More preferred is 40 vol % or more and 66 vol % or less.

Examples of a particle (hereinafter, also called “second particle”) other than the organic-inorganic composite particle as contained in the surface layer of the electrophotographic photosensitive member of the present invention include an organic resin particle (e.g., an acrylic resin particle), an inorganic particle (e.g., an alumina, silica, or titania particle), or an organic-inorganic hybrid particle.

Examples of the organic resin particle include cross-linked polystyrene, cross-linked acrylic resin, phenolic resin, melamine resin, polyethylene, polypropylene, an acrylic particle, a polytetrafluoroethylene particle, or a silicone particle.

The acrylic particle contains a polymer of acrylic ester or methacrylic ester. Among them, a styrene acrylic particle is more preferred. There are no restrictions on the degree of polymerization of acrylic resin or styrene acrylic resin, or whether the resin is thermoplastic or thermosetting.

The polytetrafluoroethylene particle may mainly contain tetrafluoroethylene resin, and may also contain trifluoroethylene chloride resin, propylene hexafluoride resin, vinyl fluoride resin, vinylidene fluoride resin, or difluorodiethylene chloride resin.

Examples of the organic-inorganic hybrid particle include a polymethylsilsesquioxane particle containing siloxane linkage.

As the inorganic microparticle contained in the organic-inorganic composite particle on the surface layer of the electrophotographic photosensitive member of the present invention, it is preferable to use an inorganic microparticle that has high hardness and is advantageous with respect to point contact with the toner.

Examples of the inorganic particle include magnesium oxide, zinc oxide, lead oxide, tin oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium oxide, niobium oxide, molybdenum oxide, vanadium oxide, copper aluminum oxide, tin oxide doped with antimony ions, or hydrotalcite. These particles may be used singly or two or more kinds thereof may be used in combination. In addition, the particle may be a synthetic product or a commercially available product. Further, a silica particle is preferred as the inorganic particle.

As the silica particle, each known silica microparticle may be used, and the silica particle may be either a dry silica microparticle or wet silica microparticle. Preferred is a wet silica microparticle obtained by the sol-gel method (hereinafter also referred to as “sol-gel silica”).

The sol-gel silica used for the particles contained in the surface layer of the electrophotographic photosensitive member of the present invention may be hydrophilic or may have its surface hydrophobically treated.

Examples of the hydrophobic treatment method include a sol-gel method in which a solvent is removed from a silica-sol suspension, and the suspension is dried and then treated with a hydrophobic treatment agent or a sol-gel method in which a hydrophobic treatment agent is added directly to a silica-sol suspension and the suspension is treated simultaneously while dried. From the viewpoints of controlling the width of the half value for the particle diameter distribution and controlling the saturated water adsorption, the method of adding a hydrophobic treatment agent directly to a silica sol suspension is preferred.

Examples of the hydrophobic treatment agent include the following:
chlorosilanes (e.g., methyltrichlorosilane, dimethyldichlorosilane, trimethylchlorosilane, phenyltrichlorosilane, diphenyldichlorosilane, t-butyldimethylchlorosilane, vinyltrichlorosilane);
alkoxysilanes (e.g., tetramethoxysilane, methyltrimethoxysilane, dimethyldimethoxysilane, phenyltrimethoxysilane, diphenyldimethoxysilane, O-methylphenyltrimethoxysilane, p-methylphenyltrimethoxysilane, n-butyltrimethoxysilane, i-butyltrimethoxysilane, hexyltrimethoxysilane, octyltrimethoxysilane, decyltrimethoxysilane, dodecyltrimethoxysilane, tetraethoxysilane, methyltriethoxysilane dimethyldiiethoxysilane, phenyltriethoxysilane, diphenyldiethoxysilane, i-butyltriethoxysilane, decyltriethoxysilane, vinyltriethoxysilane, γ-methacryloxypropyltrimethoxysilane, γ-glycidoxypropyltrimethoxysilane, γ-glycidoxypropylmethyldimethoxysilane, γ-mercaptopropyltrimethoxysilane, γ-chloropropyltrimethoxysilane, γ-aminopropyltrimethoxysilane, γ-aminopropyltriethoxysilane, γ-(2-aminoethyl)aminopropyltrimethoxysilane, γ-(2-aminoethyl)aminopropylmethyldimethoxysilane);
silazanes (e.g., hexamethyldisilazane, hexaethyldisilazane, hexapropyldisilazane, hexabutyldisilazane, hexapentyldisilazane, hexahexyldisilazane, hexacyclohexyldisilazane, hexaphenyldisilazane, divinyltetramethyldisilazane, dimethyltetravinyldisilazane);
silicone oils (e.g., dimethyl silicone oil, methyl hydrogen silicone oil, methyl phenyl silicone oil, alkyl-modified silicone oil, chloroalkyl-modified silicone oil, chlorophenyl-modified silicone oil, fatty acid-modified silicone oil, polyether-modified silicone oil, alkoxγ-modified silicone oil, carbinol-modified silicone oil, amino-modified silicone oil, fluorine-modified silicone oil, end-reactive silicone oil);
siloxanes (e.g., hexamethylcyclotrisiloxane, octamethylcyclotetrasiloxane, decamethylcyclopentasiloxane, hexamethyldisiloxane, octamethyltrisiloxane); or
fatty acids and their metal salts (e.g., long-chain fatty acids (e.g., undecyl acid, lauric acid, tridecyl acid, dodecyl acid, myristic acid, palmitic acid, pentadecyl acid, stearic acid, heptadecyl acid, arachic acid, montanoic acid, oleic acid, linoleic acid, arachidonic acid) and salts of the above fatty acids with a metal (e.g., zinc, iron, magnesium, aluminum, calcium, sodium, lithium)).

Among these, alkoxysilanes, silazanes, or silicone oils are preferably used because they are easy to hydrophobize. One of these hydrophobic treatment agents may be used singly, or two or more thereof may be used in combination.

A conductive particle or charge transport substance may be added to a coating liquid for the surface layer to improve the charge transport capability of the surface layer. A conductive pigment used for the conductive layer may be used as the conductive particle. Each charge transport substance described below may be used as the charge transport substance. Additives may also be added to improve various functions. Examples of the additives include a conductive particle, an antioxidant, a UV absorber, a plasticizer, and/or a leveling agent.

In the present invention, the surface layer may be provided to improve the durability of the surface of the electrophotographic photosensitive member.

As mentioned above, the surface layer has to contain a binder resin and organic-inorganic composite particles to achieve the purpose of the present invention. In addition, the surface layer preferably contains particles other than the organic-inorganic composite particles and/or a charge transporting substance.

Examples of the charge transporting substance include a polycyclic aromatic compound, a heterocyclic compound, a hydrazone compound, a styryl compound, an enamine compound, a benzidine compound, a triarylamine compound, or a resin with a group derived from these substances. Among them, a triarylamine compound or a benzidine compound is preferred.

Examples of the binder resin include polyester resin, acrylic resin, phenoxy resin, polycarbonate resin, polystyrene resin, phenol resin, melamine resin, or epoxy resin. Among them, polycarbonate resin, polyester resin, or acrylic resin is preferred.

In addition, the surface layer may have a cured film obtained by polymerizing a composition containing a monomer having a polymerizable functional group. Examples of the reaction at that time include a thermal polymerization reaction, a photopolymerization reaction, or a radiation polymerization reaction. Examples of the polymerizable functional group possessed by the monomer with a polymerizable functional group include an acryloyl group or a methacryloyl group. The monomer with a polymerizable functional group may use a material having a charge transport capability.

The compound with a polymerizable functional group may have a charge-transporting structure as well as a chain-polymerizable functional group. A triarylamine structure is preferred as the charge-transporting structure in terms of charge transport. An acryloyl group or a methacryloyl group is preferred as the chain-polymerizable functional group. The number of functional groups may be one or more. Among them, formation of a cured film by including a compound with multiple functional groups and a compound with one functional group is particularly preferred, because the strain caused by polymerization between the multiple functional groups is easily resolved.

Examples of the compound with one functional group are shown in the following structural formulas (2-1) to (2-6):

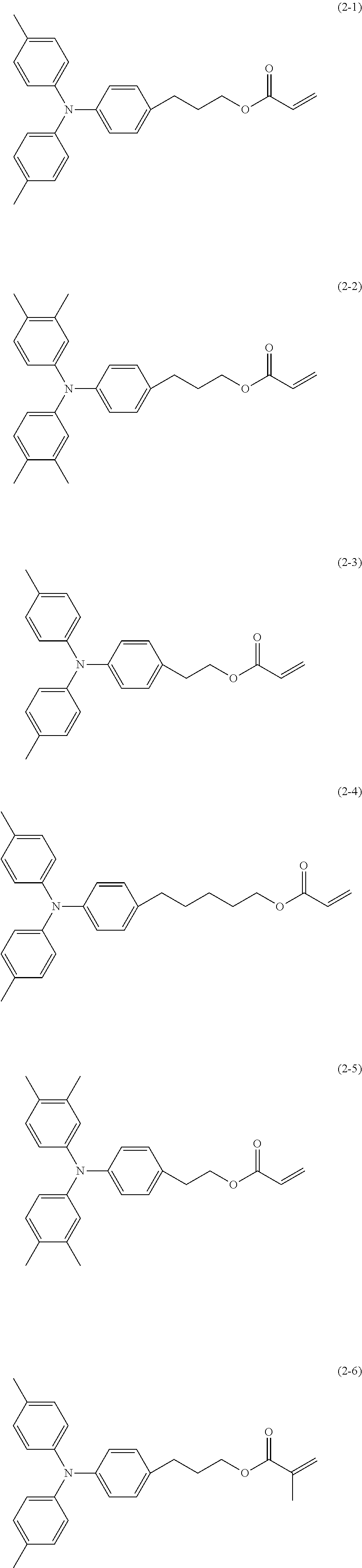 [SMILES: C=CC(=O)OCCCc1ccc(N(c2ccc(C)cc2)c2ccc(C)cc2)cc1 ; C=CC(=O)OCCCc1ccc(N(c2ccc(C)c(C)c2)c2ccc(C)c(C)c2)cc1 ; C=CC(=O)OCCc1ccc(N(c2ccc(C)cc2)c2ccc(C)cc2)cc1 ; C=CC(=O)OCCCCCc1ccc(N(c2ccc(C)cc2)c2ccc(C)cc2)cc1 ; C=CC(=O)OCCc1ccc(N(c2ccc(C)c(C)c2)c2ccc(C)c(C)c2)cc1 ; C=C(C)C(=O)OCCCc1ccc(N(c2ccc(C)cc2)c2ccc(C)cc2)cc1]

Examples of the compound with multiple functional groups are shown in the following structural formulas (3-1) to (3-6):

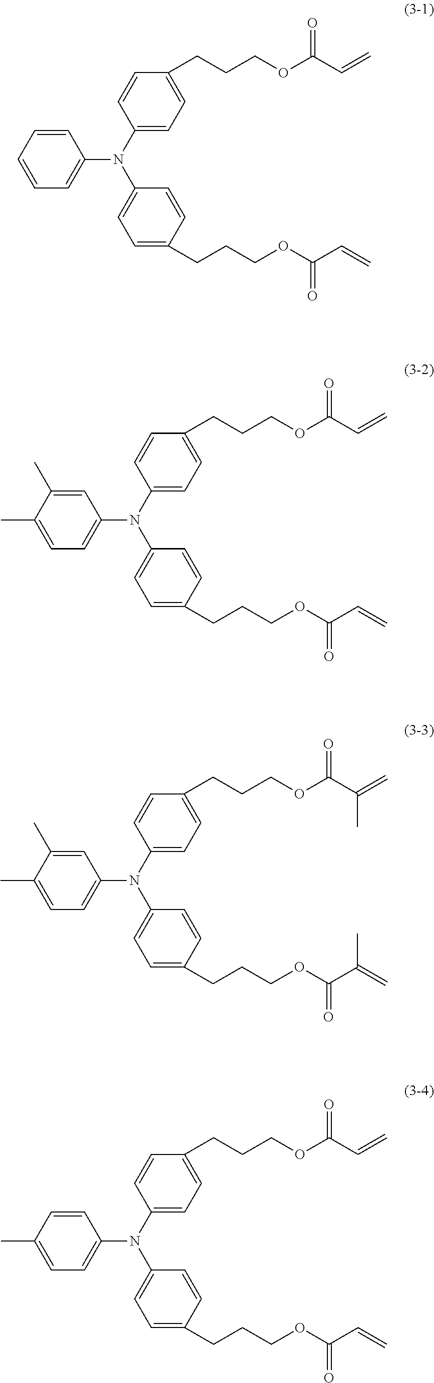

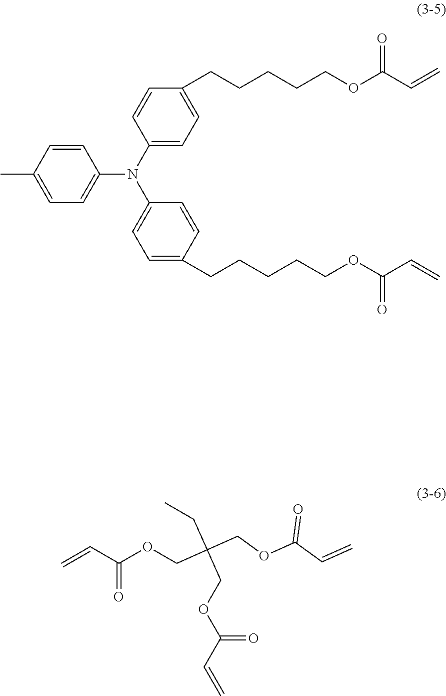

The surface layer may contain additives such as an antioxidant, a UV absorber, a plasticizer, a leveling agent, a slipping agent, and/or a wear resistance improver. Specific examples include a hindered phenol compound, a hindered amine compound, a sulfur compound, a phosphorus compound, a benzophenone compound, siloxane-modified resin, or silicone oil.

The surface layer may be formed by preparing a coating liquid for the surface layer, which coating liquid contains the above-mentioned materials and a solvent, forming the resulting coating film on a charge transport layer or single-layer photosensitive layer, and drying and/or curing the coating film. Examples of the solvent used for the coating liquid include an alcohol-based solvent, a ketone-based solvent, an ether-based solvent, a sulfoxide-based solvent, an ester-based solvent, or an aromatic hydrocarbon-based solvent.

The average film thickness of the surface layer is preferably 0.2 μm or more and 10 μm or less, and preferably 0.3 μm or more and 7 μm or less.

In the electrophotographic photosensitive member of the present invention, either a stacked type photosensitive layer having a charge generation layer and a charge transport layer on a support, or a monolayer type photosensitive layer containing both a charge generation substance and a charge transport substance on a support may be used. Either structure has a surface layer with particles dispersed on its surface layer.

The following describes the support and each layer.

### Support

In the present invention, the electrophotographic photosensitive member should have a support. In the present invention, the support is preferably a conductive support having conductive properties. Here, examples of the shape of the support include a cylindrical shape, a belt shape, or a sheet shape. Among them, a cylindrical support is preferred. In addition, the surface of the support may be subjected to electrochemical treatment such as anodic oxidation, blasting treatment, or cutting treatment.

A metal, resin, or glass, for instance, is preferred as a material of the support.

Examples of the metal include aluminum, iron, nickel, copper, gold, stainless steel, or an alloy thereof. Among them, an aluminum support using aluminum is preferred.

In addition, resin or glass may be given conductivity by mixing or coating with a conductive material.

### <Conductive Layer>

In the present invention, a conductive layer may be provided on the support. The conductive layer may be provided to hide scratches and irregularities on the support surface and control the reflection of light on the support surface.

The conductive layer preferably contains conductive particles and a resin.

Examples of a material for the conductive particles include a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, or bismuth oxide. Examples of the metal include aluminum, nickel, iron, nichrome, copper, zinc, or silver.

Among these, as the conductive particle, a metal oxide is preferably used, and titanium oxide, tin oxide, or zinc oxide is more preferably used.

When a metal oxide is used as the conductive particle, the surface of the metal oxide may be treated with a silane coupling agent or the like or the metal oxide may be doped with an element (e.g., phosphorus, aluminum) or an oxide thereof.

In addition, the conductive particle may also have a laminated structure with a core particle and a coating layer that covers the particle. Examples of the core particle include titanium dioxide, barium sulfate, or zinc oxide. Examples of the coating layer include a metal oxide such as tin oxide.

When a metal oxide is used as the conductive particle, the average primary particle diameter is preferably 1 nm or more and 500 nm or less, and more preferably 3 nm or more and 400 nm or less.

Examples of the resin include polyester resin, polycarbonate resin, polyvinyl acetal resin, acrylic resin, silicone resin, epoxy resin, melamine resin, polyurethane resin, phenolic resin, or alkyd resin.

In addition, the conductive layer may further contain, for instance, a hiding agent such as silicone oil, resin particles, or titanium dioxide.

The average film thickness of the conductive layer is preferably 1 μm or more and 50 μm or less, and particularly preferably 3 μm or more and 40 μm or less.

The conductive layer may be formed by preparing a coating liquid for the conductive layer, which coating liquid contains the above-mentioned materials and a solvent and forming and drying the resulting coating film. Examples of the solvent used in the coating liquid include an alcohol-based solvent, a sulfoxide-based solvent, a ketone-based solvent, an ether-based solvent, an ester-based solvent, or an aromatic hydrocarbon-based solvent. Examples of the dispersion method for dispersing conductive particles in the coating liquid for the conductive layer include a method using a paint shaker, a sand mill, a ball mill, or a liquid-impact high-speed dispersion machine.

### <Undercoat Layer>

In the present invention, an undercoat layer may be provided over the support or conductive layer.

The average film thickness of the undercoat layer is preferably 0.1 μm or more and 50 μm or less, more preferably 0.2 μm or more and 40 μm or less, and particularly preferably 0.3 μm or more and 30 μm or less.

Examples of a resin used for this undercoat layer include polyacrylic acid resin, polyvinyl alcohol resin, polyvinyl acetal resin, polyethylene oxide resin, polypropylene oxide resin, ethyl cellulose resin, methyl cellulose resin, polyamide resin, polyamide acid resin, polyurethane resin, polyimide resin, polyamideimide resin, polyvinyl phenol resin, melamine resin, phenol resin, epoxy resin, or alkyd resin.

The resin may have a structure obtained by cross-linking a resin having a polymerizable functional group and a monomer having a polymerizable functional group.

In addition to the resin, the undercoat layer may contain an inorganic compound and/or an organic compound.

Examples of the inorganic compound include a metal, an oxide and/or a salt.

Examples of the metal include gold, silver, or aluminum. Examples of the oxide include zinc oxide, lead white, aluminum oxide, indium oxide, silicon oxide, zirconium oxide, tin oxide, titanium oxide, magnesium oxide, antimony oxide, bismuth oxide, indium oxide, tin oxide, or zirconium oxide. Examples of the salt include barium sulfate or strontium titanate.

These inorganic compounds may be present in the film in a particulate form.

The number-average primary particle diameter of the particles is preferably 1 nm or more and 500 nm or less, and more preferably 3 nm or more and 400 nm or less.

These inorganic compounds may have a laminated structure with a core particle and a coating layer that covers the particle.

The surface of these inorganic compounds may be treated with, for instance, silicone oil, a silane compound, a silane coupling agent, or another organic silicon compound or an organic titanium compound. The surface may also be doped with an element such as tin, phosphorus, aluminum, and/or niobium.

Examples of the organic compound include an electron transporting substance and/or a conductive polymer.

Examples of the conductive polymer include polythiophene, polyaniline, polyacetylene, polyphenylene, or polyethylenedioxythiophene.

Examples of the electron transporting substance include a quinone compound, an imide compound, a benzimidazole compound, a cyclopentadienylidene compound, a fluorenone compound, a xanthone compound, a benzophenone compound, a cyanovinyl compound, an aryl halide compound, a silole compound, or a boron-containing compound.

The electron transporting substance may have a polymerizable functional group and may be cross-linked with a resin having a functional group that can react with the above functional group. Examples of the polymerizable functional group include a hydroxy group, a thiol group, an amino group, a carboxyl group, a vinyl group, an acryloyl group, a methacryloyl group, or an epoxy group.

These organic compounds may be present in the film in a particulate form or may be surface-treated.

The undercoat layer may be admixed with various additives such as a leveling agent (e.g., silicone oil), a plasticizer, and/or a thickener.

The undercoat layer is obtained by preparing a coating liquid for the undercoat layer, which coating liquid contains the above materials, applying the coating liquid to a support or conductive layer, and then drying and/or curing the resulting coating film.

Examples of a solvent used to prepare the coating liquid include an alcohol-based solvent, a ketone-based solvent, an ether-based solvent, an ester-based solvent, or an aromatic hydrocarbon-based solvent.

Examples of a dispersion method for dispersing particles in the coating liquid include a method using a paint shaker, a sand mill, a ball mill, or a liquid-impact high-speed dispersion machine.

### <Photosensitive Layer>

The photosensitive layer of an electrophotographic photosensitive member is mainly classified into (1) a stacked photosensitive layer and (2) a single-layer photosensitive layer. (1) The stacked photosensitive layer has a charge generation layer containing a charge generating substance and a charge transport layer containing a charge transporting substance. (2) The single-layer photosensitive layer is a photosensitive layer that contains both a charge generating substance and a charge transporting substance.

### (1) Stacked Photosensitive Layer

The stacked photosensitive layer has a charge generation layer and a charge transport layer.

### (1-1) Charge Generation Layer

The charge generation layer preferably contains a charge generating substance and a resin.

Examples of the charge generating substance include an azo pigment, a perylene pigment, a polycyclic quinone pigment, an indigo pigment, or a phthalocyanine pigment. Among them, an azo pigment or a phthalocyanine pigment is preferred. Among phthalocyanine pigments, an oxytitanium phthalocyanine pigment, a chlorogallium phthalocyanine pigment, or a hydroxygallium phthalocyanine pigment is preferred.

The content of the charge generating substance in the charge generation layer is preferably 40 mass % or more and 85 mass % or less and more preferably 60 mass % or more and 80 mass % or less based on the total mass of the charge generation layer.

Examples of the resin include polyester resin, polycarbonate resin, polyvinyl acetal resin, polyvinyl butyral resin, acrylic resin, silicone resin, epoxy resin, melamine resin, polyurethane resin, phenol resin, polyvinyl alcohol resin, cellulose resin, polystyrene resin, polyvinyl acetate resin, or polyvinyl chloride resin. Among them, polyvinyl butyral resin is more preferred.

In addition, the charge generation layer may further contain additives such as an antioxidant and/or a UV absorber. Specific examples include a hindered phenol compound, a hindered amine compound, a sulfur compound, a phosphorus compound, or a benzophenone compound.

The average film thickness of the charge generation layer is preferably 0.1 μm or more and 1 μm or less, and more preferably 0.15 μm or more and 0.4 μm or less.

The charge generation layer may be formed by preparing a coating liquid for the charge generation layer, which coating liquid contains the above-mentioned materials and a solvent, forming the resulting coating film on a support or on a conductive layer or undercoat layer to be described later, and drying the coating film. Examples of the solvent used in the coating liquid include an alcohol-based solvent, a sulfoxide-based solvent, a ketone-based solvent, an ether-based solvent, an ester-based solvent, or an aromatic hydrocarbon-based solvent.

### (1-2) Charge Transport Layer

The charge transport layer preferably contains a charge transporting substance and a resin.

Examples of the charge transporting substance include a polycyclic aromatic compound, a heterocyclic compound, a hydrazone compound, a styryl compound, an enamine compound, a benzidine compound, a triarylamine compound, or a resin with a group derived from these substances. Among them, a triarylamine compound or a benzidine compound is preferred, and those with the structure of the following formula (1) are suitably used.

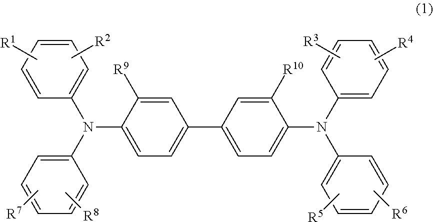

wherein R¹ to R¹⁰ each independently represent a hydrogen atom or a methyl group.

Examples of the structure represented by formula (1) are shown in formulas (1-1) through (1-10). Among them, the structures represented by formulas (1-1) to (1-6) are more preferred.

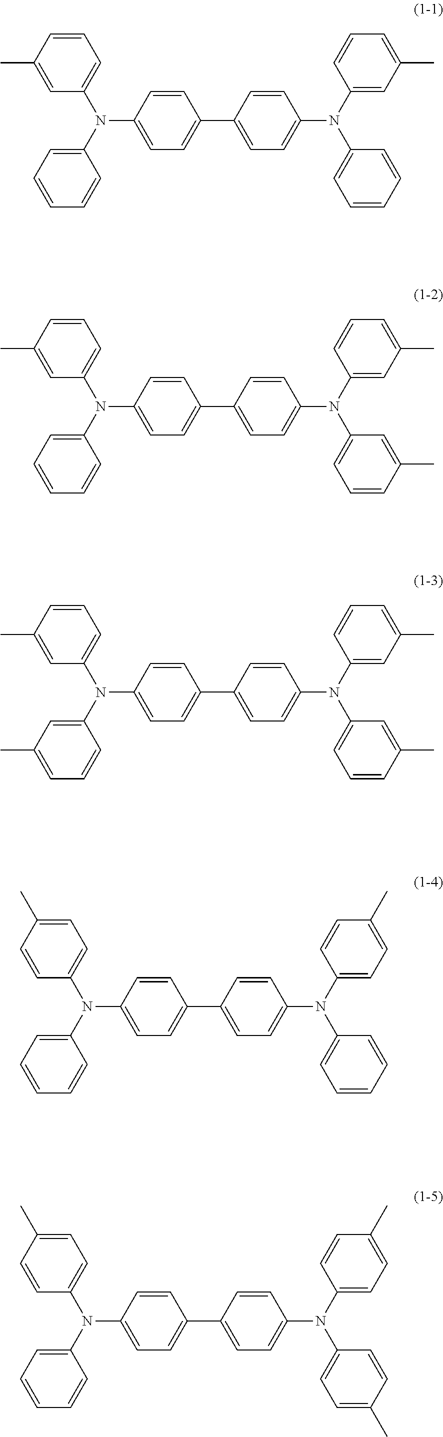

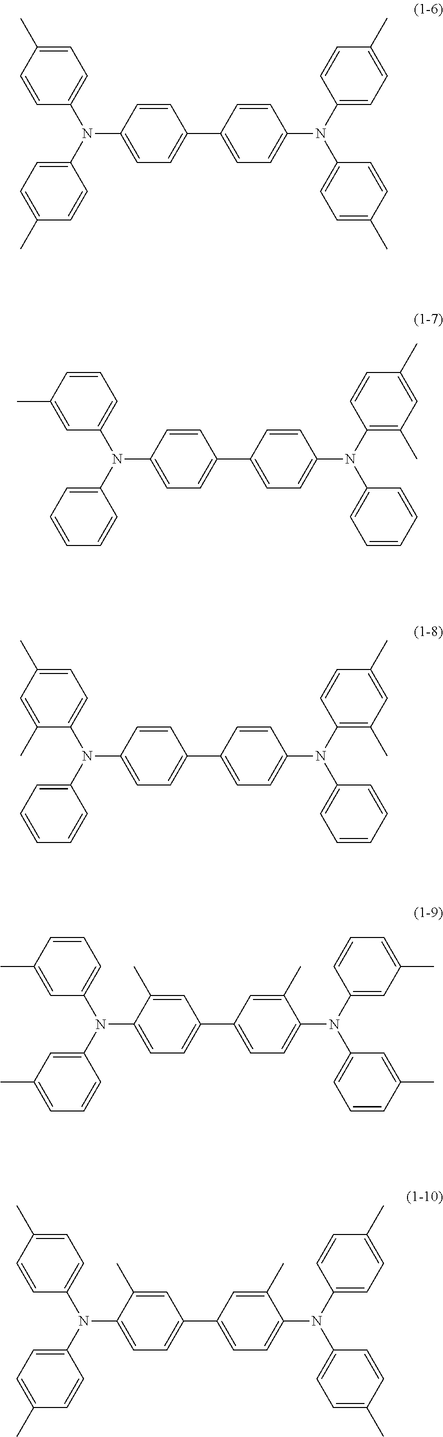

The resin used is a thermoplastic resin, and examples include polyester resin, polycarbonate resin, acrylic resin, or polystyrene resin. Among them, polycarbonate resin or polyester resin is preferred. As the polyester resin, polyarylate resin is particularly preferred.

The content of the charge transporting substance in the charge transport layer is preferably 25 mass % or more and 70 mass % or less, and more preferably 30 mass % or more and 55 mass % or less based on the total mass of the charge transport layer.

The content ratio (mass ratio) of the charge transporting substance to the resin is preferably from 4/10 to 20/10, and more preferably from 5/10 to 12/10.

In addition, the charge transport layer may also contain additives such as an antioxidant, a UV absorber, a plasticizer, a leveling agent, a slipping agent, and/or a wear resistance improver. Specific examples include a hindered phenol compound, a hindered amine compound, a sulfur compound, a phosphorus compound, a benzophenone compound, a siloxane modified resin, silicone oil, fluororesin particles, polystyrene resin particles, polyethylene resin particles, silica particles, alumina particles, or boron nitride particles.

The average film thickness of the charge transport layer is preferably 5 μm or more and 50 μm or less, more preferably 8 μm or more and 40 μm or less, and particularly preferably 10 μm or more and 30 μm or less.

The charge transport layer may be formed by preparing a coating liquid for the charge transport layer, which coating liquid contains the above-mentioned materials and a solvent, forming the resulting coating film on the charge generation layer, and drying the coating film. Examples of the solvent used in the coating liquid include an alcohol-based solvent, a ketone-based solvent, an ether-based solvent, an ester-based solvent, or an aromatic hydrocarbon-based solvent. Among these solvents, an ether-based solvent or an aromatic hydrocarbon-based solvent is preferred.

In the case of using the charge transport layer as the surface layer, the particles described in the <Surface layer> section above are used.

### (2) Single-Layer Photosensitive Layer

The single-layer photosensitive layer may be formed by preparing a coating liquid for the photosensitive layer, which coating liquid contains a charge generating substance, a charge transporting substance, a resin, and a solvent, forming the resulting coating film on a support or a conductive layer or an undercoat layer, and drying the coating film. The charge generating substance, charge transporting substance, and resin are the same as the examples of materials in “(1) Stacked photosensitive layer” above.

### [Process Cartridge and Electrophotographic Apparatus]

The process cartridge of the present invention can integrally support the electrophotographic photosensitive member described so far and at least one unit selected from the group consisting of charging units, developing units, and cleaning units. The process cartridge is, as a feature, detachable from the main body of the electrophotographic apparatus. The electrophotographic apparatus of the present invention can have the above-mentioned electrophotographic photosensitive member, charging unit, exposure unit, developing unit, and transfer unit.

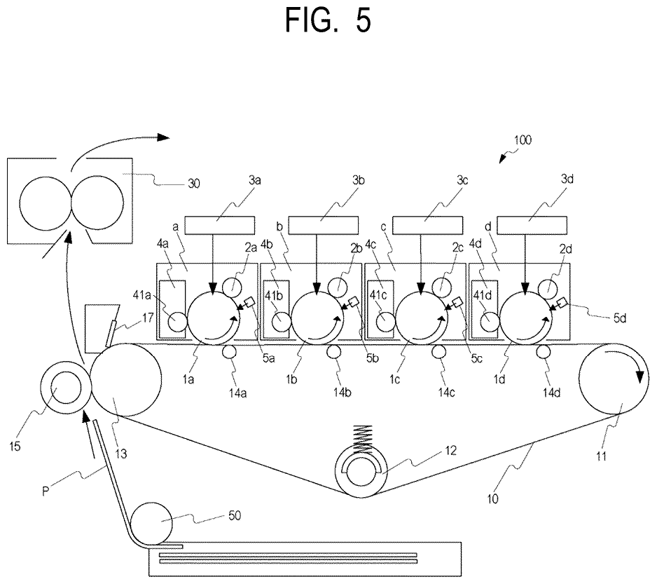

FIG. 5 shows a schematic example of the configuration of an electrophotographic apparatus with a process cartridge equipped with an electrophotographic photosensitive member of the present invention.

### [Configuration of Electrophotographic Apparatus]

The electrophotographic apparatus 100 in this Embodiment is what is called a tandem-type electrophotographic apparatus with multiple image forming sections a to d. The first image forming section a uses yellow (Y) toner, the second image forming section b uses magenta (M) toner, the third image forming section c uses cyan (C) toner, and the fourth image forming section d uses black (Bk) toner to form an image. These four image forming sections are arranged in a row at constant intervals, and many parts of the structure of each image forming section are substantially the same except for the color of toner to be housed. Then, the first image forming section a will be used to describe the electrophotographic apparatus of this Embodiment.

The first image forming section a has a drum-shaped photosensitive member, namely photoconductor drum 1a, a charging roller 2a as a charging member, a developing unit 4a, and a static eliminating unit 5a.

The photoconductor drum 1a is an image carrier that carries a toner image and is rotatably driven in the direction of the arrow in the figure at a specified peripheral speed (process speed). The developing unit 4a contains yellow toner and develops the yellow toner on the photoconductor drum 1a by using a developing roller 41a.

When a controller or other control unit (not shown) receives an image signal, the image forming operation is started and the photoconductor drum 1a is driven to rotate. In the process of rotation, the photoconductor drum 1a is uniformly charged by the charging roller 2a with a predetermined polarity (negative polarity in this Embodiment) and a predetermined voltage (charging voltage) and exposed by an exposure unit 3a according to the image signal. As a result, an electrostatic latent image corresponding to the yellow color component image of the target color image is formed on the photoconductor drum 1a. The electrostatic latent image is then developed by the developing unit 4a at the developing position and visualized as a yellow toner image on the photoconductor drum 1a. Here, the normal charging polarity of the toner contained in the developing unit 4a is negative, and the electrostatic latent image is inversely developed by the toner charged with the same polarity as that of the photoconductor drum 1a by the charging roller 2a. However, the present invention is not limited to this, and the present invention is also applicable to an electrophotographic apparatus that positively develops an electrostatic latent image with toner charged in the opposite polarity to that of the photosensitive member drum 1a. In addition, the surface layer of the charging roller 2a may be provided with a large number of convexities derived from particles. The convexities on the surface layer of the charging roller 2a each serves as a spacer between the charging roller 2a and the photoconductor drum 1a in the charging section. This role is to prevent, when post-transfer residual toner, which is toner remaining on the photoconductor drum 1a without being transferred in the primary transfer section described later, enters the charging section, contamination of the charging roller 2a with the post-transfer residual toner because portions other than the convexities come into contact with the post-transfer residual tonner.

The exposure unit 5a as a static eliminating unit eliminates static by exposing the surface of the photoconductor drum 1a before the surface of the photoconductor drum 1a is charged by the charging roller 2a. The static of the surface of the photoconductor drum 1a is eliminated to play a role of equalizing the surface potential formed on the photoconductor drum 1 and a role of controlling the amount of discharge caused by the electrical discharge that occurs in the charging section.

An endless and movable intermediate transfer belt 10 is conductive and has a primary transfer section in contact with the photoconductor drum 1a, and rotates at substantially the same peripheral speed as that of the photoconductor drum 1a. The intermediate transfer belt 10 is installed and tensioned by a counter roller 13 as a counter member, and a drive roller 11, a tensioning roller 12, and a metal roller 14a as tensioning members. The tension is adjusted by the tensioning roller 12 at a total pressure of 60 N. The intermediate transfer belt 10 can be moved by the drive roller 11 being rotated and driven in the direction of the arrow in the figure.

The yellow toner image formed on the photoconductor drum 1a is primarily transferred from the photoconductor drum 1a to the intermediate transfer belt 10 in the process of passing through the primary transfer section.

Note that in the second, third, and fourth image forming sections in FIG. 5, the photoconductor drums are 1b, 1c, and 1d, the charging rollers are 2b, 2c, and 2d, the exposure units are 3b, 3c, and 3d, the developing units are 4b, 4c, and 4d, the static eliminating units are 5b, 5c, and 5d, the metal rollers are 14b, 14c, and 14d, and the developing rollers are 41b, 41c, and 41d, respectively.

Next, in the same manner, the second color magenta toner image, the third color cyan toner image, and the fourth color black toner image are formed and sequentially transferred to and superimposed on the intermediate transfer belt 10. As a result, a four-color toner image corresponding to the desired color image is formed on the intermediate transfer belt 10. The four-color toner image carried on the intermediate transfer belt 10 is then batch-transferred secondarily to the surface of a transfer material P, such as paper or OHP sheet fed by a paper feeding unit 50, in the process of passing through the secondary transfer section formed while the secondary transfer roller 15 and the intermediate transfer belt 10 are brought into contact. The transfer material P onto which the four-color toner image is transferred by the secondary transfer is then heated and pressurized in a fixing unit 30, so that the four-color toners are melted and mixed, and are then fixed on the transfer material P. The toner remaining on the intermediate transfer belt 10 after the secondary transfer is cleaned and removed by a belt cleaning unit 17 provided facing the counter roller 13 via the intermediate transfer belt 10.

The electrophotographic photosensitive member of the present invention can be used in laser beam printers, LED printers, copy machines, etc.

### EXAMPLES

The following Examples and Comparative Examples are used to further describe the present invention in detail. The present invention is not limited in any way by the following Examples as long as not departing from the spirit of the present invention.

Note that in the following Examples, the term “parts” is on a mass basis unless otherwise noted.

The film thickness of each layer of the electrophotographic photosensitive member in the Examples and Comparative Examples, except for the surface layer and the charge generation layer, was determined by a method using an eddy-current film thickness meter (Fischerscope, manufactured by Fischer Instruments) or by a method of measuring the film thickness from the mass per unit area in terms of specific gravity. The film thickness of the charge generation layer was measured by converting the Macbeth density value of the photosensitive member while using a calibration curve obtained beforehand from the Macbeth density value measured by pressing a spectrodensitometer (trade name: X-Rite 504/508, manufactured by X-Rite) against the photosensitive member surface and the film thickness value measured by cross-sectional SEM image observation.

### <To Prepare Coating Liquid 1 for Conductive Layer>

Anatase-type titanium dioxide with an average primary particle diameter of 200 nm was used as a base material, and a titanium-niobium sulfate solution containing 33.7 parts of titanium in terms of TiO₂ and 2.9 parts of niobium in terms of Nb₂O₅ was prepared. Here, 100 parts of the base material was dispersed in pure water to prepare 1000 parts of a suspension, which was heated to 60° C. Titanium niobium sulfate solution and 10 mol/L sodium hydroxide were added dropwise over 3 hours to bring the pH of the suspension to 2 to 3. After dropping the entire volume, the pH was adjusted to near neutral and a polyacrylamide-based flocculant was added to allow solids to settle. The supernatant was removed, and the solids were filtered and washed, and dried at 110° C. to obtain an intermediate containing 0.1 wt % of the flocculant-derived organic matter in terms of C. This intermediate was calcined at 750° C. in nitrogen for 1 hour and then at 450° C. in air to produce a titanium dioxide particle 1. The obtained particles had an average primary particle diameter of 220 nm in the above-mentioned particle diameter measurement method using a scanning electron microscope.

Then, 50 parts of phenolic resin (monomer/oligomer of phenolic resin) (product name: PLYOPHEN J-325, manufactured by DIC Corporation; resin solid content: 60%; density after curing: 1.3 g/cm²) as a binder material was dissolved in 35 parts of 1-methoxy-2-propanol as a solvent to prepare a solution.

This solution was admixed with 60 parts of titanium dioxide particle 1, and the solution was placed in a vertical sand mill using 120 parts of glass beads with a number-average primary particle diameter of 1.0 mm as a dispersing medium, and dispersed for 4 hours under conditions at a dispersion temperature of 23±3° C. and a rotation speed of 1500 rpm (peripheral speed of 5.5 m/s) to give a dispersion. The glass beads were removed using a mesh from this dispersion. The dispersion after the glass beads were removed was admixed with 0.01 parts of silicone oil (trade name: SH28 PAINT ADDITIVE, manufactured by Toray Dow Corning) as a leveling agent, and 8 parts of silicone resin particle (trade name: KMP-590, manufactured by Shin-Etsu Chemical Co., Ltd.; average primary particle diameter: 2 μm; density: 1.3 g/cm³) as a surface roughening material, and the mixture was stirred. The mixture was subjected to pressure filtration through PTFE filter paper (trade name: PF060, manufactured by ADVANTEC TOYO, KAISHA, LTD.) to prepare a coating liquid 1 for the conductive layer.

### <To Prepare Coating Liquid 1 for Undercoat Layer>

First, 100 parts of rutile-type titanium dioxide particle (average primary particle diameter: 50 nm; manufactured by TAYCA CORPORATION) was mixed with 500 parts of toluene, and 3.5 parts of vinyl trimethoxysilane (trade name: KBM-1003, manufactured by Shin-Etsu Chemical, Co., Ltd.) was added. The mixture was dispersed for 8 hours in a vertical sand mill using glass beads with a diameter of 1.0 mm. After removing the glass beads, toluene was distilled away by vacuum distillation and the remainder was dried at 120° C. for 3 hours to produce a rutile-type titanium dioxide particle that had been surface-treated with an organosilicon compound. When the volume of the obtained titanium dioxide particle was set to a and the average primary particle diameter of the titanium dioxide particle was set to b [μm], a/b=15.6. The value of a was determined from the microscopic image of a cross section of an electrophotographic photosensitive member by field emission scanning electron microscopy (FE-SEM; trade name: S-4800, manufactured by Hitachi High-Tech Corporation) after the electrophotographic photosensitive member was fabricated.

A dispersion was prepared by adding 18.0 parts of rutile-type titanium dioxide particle that had been surface-treated with the above organosilicon compound, 4.5 parts of N-methoxymethylated nylon (trade name: Tresin EF-30T, manufactured by Nagase ChemteX Corporation), and 1.5 parts of copolymerized nylon resin (trade name: Amilan CM8000, manufactured by Toray Industries, Inc.) to a mixture of 90 parts of methanol and 60 parts of 1-butanol.

This dispersion was dispersed for 5 hours in a vertical sand mill using glass beads with a diameter of 1.0 mm, and the glass beads were removed to prepare a coating liquid 1 for the undercoat layer.

### <To Synthesize Phthalocyanine Pigment>

### Synthesis Example

To 1000 mL of α-chloronaphthalene, 100 g of gallium trichloride and 291 g of ortho-phthalonitrile were added under an atmosphere of nitrogen flow, and the reaction was carried out at a temperature of 200° C. for 24 hours. The product was then filtered. The resulting wet cake was heated and stirred with N,N-dimethylformamide at 150° C. for 30 minutes, and then filtered. The filtered material obtained was washed with methanol and dried to give a chlorogallium phthalocyanine pigment in 83% yield.

Then, 20 g of the chlorogallium phthalocyanine pigment obtained by the above procedure was dissolved in 500 mL of concentrated sulfuric acid. The mixture was stirred for 2 hours, and then added dropwise to a mixed solution of 1700 mL of ice-cold distilled water and 660 mL of concentrated ammonia water, and was re-precipitated. The pigment was washed thoroughly with distilled water and dried to produce a hydroxygallium phthalocyanine pigment.

### <To Prepare Coating Liquid 1 for Charge Generation Layer>

First, 0.5 parts of the hydroxygallium phthalocyanine pigment obtained in the Synthetic Example, 7.5 parts of N,N-dimethylformamide (product code: D0722, manufactured by Tokyo Chemical Industry Co., Ltd.), and 29 parts of glass beads with a diameter of 0.9 mm were milled at a temperature of 25° C. for 24 hours by using a sand mill (BSG-20, manufactured by IMEX CO., Ltd.). At that time, the discs were rotated at a speed of 1500 revolutions per minute. The resulting process liquid was filtered through a filter (product No. N-NO.125T; pore size: 133 μm, manufactured by NBC Meshtec Inc.) to remove the glass beads. After admixed with 30 parts of N,N-dimethylformamide, the liquid was filtered, and the filtration residue on the filter was washed thoroughly with n-butyl acetate. The washed filtration residue was then vacuum dried to give 0.45 parts of hydroxygallium phthalocyanine pigment. The resulting pigment contained N,N-dimethylformamide.

Then, 20 parts of the resulting milled hydroxygallium phthalocyanine pigment, 10 parts of polyvinyl butyral (trade name: S-LEC BX-1, manufactured by SEKISUI CHEMICAL CO., LTD.), 190 parts of cyclohexanone, and 482 parts of glass beads with a diameter of 0.9 mm were dispersed at a cooling water temperature of 18° C. for 4 hours by using a sand mill (K-800, manufactured by Igarashi Machine Production Co., Ltd. (now AIMEX CO., Ltd.); disc diameter: 70 mm; the number of discs: 5). At that time, the discs were rotated at a speed of 1800 revolutions per minute. The glass beads were removed from the dispersion and 444 parts of cyclohexanone and 634 parts of ethyl acetate were added to prepare a coating liquid 1 for the charge generation layer.

### <To Prepare Coating Liquid 1 for Charge Transport Layer>

As a charge transporting substance, 3.6 parts of triarylamine compound of the following formula (CTM-1):

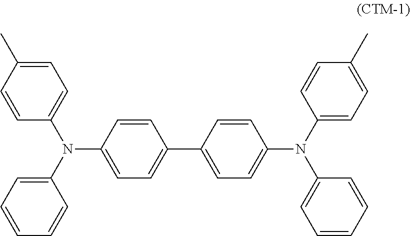 [SMILES: Cc1ccc(N(c2ccccc2)c2ccc(-c3ccc(N(c4ccccc4)c4ccc(C)cc4)cc3)cc2)cc1]

5.4 parts of triarylamine compound of the following formula (CTM-2):

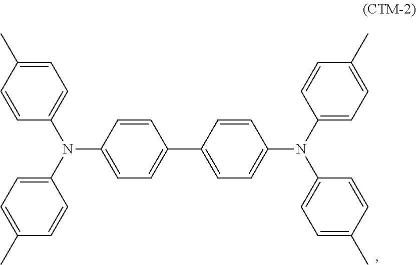 [SMILES: Cc1ccc(N(c2ccc(C)cc2)c2ccc(-c3ccc(N(c4ccc(C)cc4)c4ccc(C)cc4)cc3)cc2)cc1]

10 parts of polycarbonate resin (trade name: Iupilon Z-400, manufactured by Mitsubishi Engineering-Plastics Corporation) were dissolved in a mixed solvent of 25 parts of ortho-xylene, 25 parts of methyl benzoate, and 25 parts of dimethoxymethane to prepare a coating liquid 1 for the charge transport layer.

### <To Prepare Coating Liquid 2 for Charge Transport Layer>

As a charge transporting substance, 9 parts of triphenylamine compound of the following formula (CTM-3):

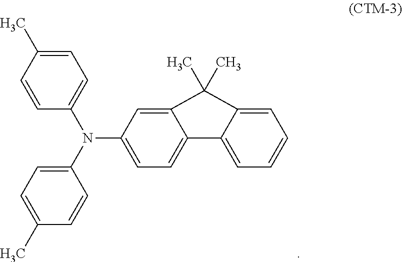 [SMILES: Cc1ccc(N(c2ccc(C)cc2)c2ccc3c(c2)C(C)(C)c2ccccc2-3)cc1]

10 parts of polyarylate resin having the structural unit represented by formula (3-1) below, and the structural unit represented by formula (3-2) below at the ratio of 5/5 and having a weight-average molecular weight of 100,000 were dissolved in a mixed solvent of 30 parts of dimethoxymethane and 70 parts of chlorobenzene to prepare a coating liquid 2 for the charge transport layer.

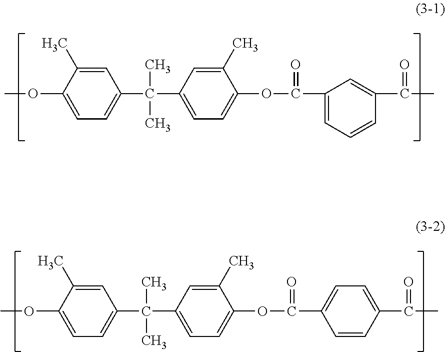

### Production Example 1 of Organic-Inorganic Composite Particle

The following materials were fed into a 250-mL, four-necked, round-bottomed flask equipped with an overhead stirring motor, a condenser, and a thermocouple.
ST-50-T (manufactured by Nissan Chemical Corporation: water dispersion of colloidal silica particle; particle diameter: 22 nm; solid content: 48 wt %) 15.6 parts
Methacryloxypropyl-trimethoxysilane (polymerizable silane coupling agent, manufactured by Tokyo Chemical Industry Co., Ltd., abbreviated as MPS) 16.5 parts
Ion-exchanged water 125 parts

The mass ratio of MPS to the colloidal silica particle was 2.2. The temperature was then increased to 65° C. and the mixture was stirred at 120 rpm. The alkoxysilane moiety of the polymerizable silane coupling agent MPS was reacted with the surface of the colloidal silica particle for 30 minutes. Meanwhile, the mixture was allowed to bubble through nitrogen gas.

After 3 hours, 0.16 parts of 2,2′-azobisisobutyronitrile, as a radical initiator, dissolved in 10 parts of ethanol was added and the temperature was raised to 75° C.

Polymerization proceeded for 5 hours, after which 2.3 parts of 1,1,1,3,3,3-hexamethyldisilazane was added to the mixture. The reaction was allowed to proceed for another 3 hours. The final mixture was filtered through a 170-mesh sieve to remove any coagulated material, and the dispersion was dried overnight at 120° C. in a Pyrex dish. The next day, the white powdered solids were collected and then milled using an IKA M20 universal rolling mill to produce an organic-inorganic composite particle 1. The number-average primary particle diameter of the organic-inorganic composite particle was 144 nm, and the diameter of the inorganic particle was 22 nm.

### <To Prepare Organic-Inorganic Composite Particles 2 to 23>

Organic-inorganic composite particles 2 to 23 were prepared in the same manner as in the preparation of organic-inorganic composite particle 1, except that the kind of colloidal silica particle used, the mass ratio of MPS to the colloidal silica particle, and the temperature/time of reacting the colloidal silica particle and MPS were changed in the preparation of organic-inorganic composite particle 1. Table 1 shows the number-average average primary particle diameter, the height of small convexity A, the shape factor SF-2, and the specific gravity of the organic-inorganic composite particle obtained, as well as the kind of the inorganic microparticle and the number-average primary particle diameter of the inorganic microparticle.

### <To Measure Physical Properties of Organic-Inorganic Composite Particle>

### <To Measure Number-Average Primary Particle Diameter and SF-2 of Each Organic-Inorganic Composite Particle>

The number-average primary particle diameter and SF-2 of each organic-inorganic composite particle can be calculated as follows.

SEM images of 100 organic-inorganic composite particles were taken using a scanning electron microscope (SEM) (“S-4800”, manufactured by JEOL Ltd.) at an acceleration voltage of 10 kV and a magnification of 100,000×. From the observed images, the area of the organic-inorganic composite particle was derived, and the diameter of the circle with the same area was defined as the primary particle diameter of the organic-inorganic composite particle. From the obtained SEM images, the maximum diameters of the organic-inorganic composite particles were measured, and based on these, the number-average diameter was calculated as the primary particle diameter of the conductive microparticle.

In addition, from the above images observed, the length of the outer circumference in the two-dimensional shape of the organic-inorganic composite particle was set to L, the area of the two-dimensional shape was set to S, and the shape factor SF-2 was then calculated as SF-2=(L²/S)× (100/4π). Like the number-average primary particle diameter, the average of SF-2 of a total of 100 organic-inorganic composite particles was calculated to obtain the SF-2 of the organic-inorganic composite particle.

Further, as for the measurement of the number-average primary particle diameter and SF-2 of organic-inorganic composite particle, they can also be measured directly from the electrophotographic photosensitive member in the following directions.

Specifically, pieces of samples cut out from the surface layer are cut using an ultrasonic ultramicrotome (EM5, manufactured by Leica) to a thickness of 60 to 200 nm to prepare thin samples. The thinned samples are observed using a transmission electron microscope (JEM2800, manufactured by JEOL Ltd.) in the scanning image mode, and STEM images of 100 organic-inorganic composite particles are taken at magnifications of 200,000× to 1,200,000×. The observed 2D STEM images may be used to calculate the number-average primary particle diameter and SF-2 in the same way as the above method.

### <Number-Average Primary Particle Diameter of Inorganic Microparticle>

### <Height of Small Convexity A>

Each organic-inorganic composite particle was observed using a transmission electron microscope (JEM2800, manufactured by JEOL Ltd.). For each particle, the height of small convexity A was determined for 100 particles by the following method, and the average value was used as the height of small convexity.

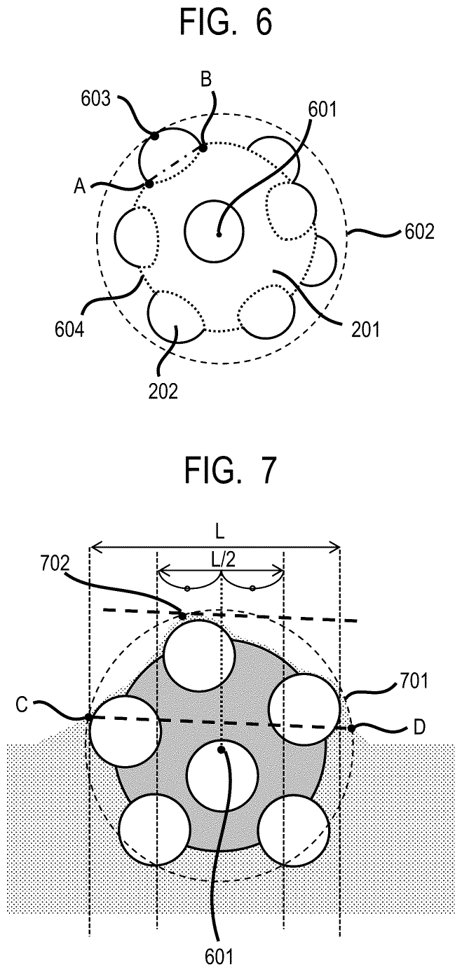

The height of small convexity A is obtained from an observed image of the organic-inorganic composite particle as shown in FIG. 6, where the two-dimensional center of gravity 601 is defined. Next, a circle 602 that had the gravity center 601 as a center and by which the organic-inorganic composite particle was circumscribed was drawn. In the organic-inorganic composite particle, the inorganic microparticles are partially embedded in the resin particle, as described above, so that the circumference point 603 in contact with the circle 602 is present on the corresponding inorganic microparticle. Points A and B where the outline 604 of the resin microparticle intersected the inorganic microparticle having the circumference point 603 were set, and the distance between the line segment AB and the circumference point 603 was defined as the height of small convexity A.

### <Specific Gravity>

The specific gravity of powder was measured by the pycnometer (liquid phase displacement) method using butanol as a dispersing solvent.

TABLE 1

| | | | Diameter of | Height of | | |
|---|---|---|---|---|---|---|
| | Particle | | inorganic | convexity | | Specific |
| | diameter | | microparticle | A | | gravity |
| | [nm] | Kind of inorganic microparticle | [nm] | [nm] | SF-2 | [g/cm³] |
| Organic-inorganic | 144 | ST-50-T (manufactured by Nissan Chemical | 22 | 11 | 109 | 1.7 |
| composite particle 1 | | Corporation) | | | | |
| Organic-inorganic | 144 | ST-30L (manufactured by Nissan Chemical | 45 | 26 | 112 | 1.7 |
| composite particle 2 | | Corporation) | | | | |
| Organic-inorganic | 144 | ST-YL (manufactured by Nissan Chemical | 60 | 36 | 115 | 1.7 |
| composite particle 3 | | Corporation) | | | | |
| Organic-inorganic | 250 | LUDOX ® TM-50 (manufactured by Sigma- | 20 | 10 | 105 | 1.5 |
| composite particle 4 | | Aldrich) | | | | |
| Organic-inorganic | 250 | ST-30L (manufactured by Nissan Chemical | 45 | 20 | 107 | 1.5 |
| composite particle 5 | | Corporation) | | | | |
| Organic-inorganic | 250 | ST-YL (manufactured by Nissan Chemical | 60 | 33 | 111 | 1.5 |
| composite particle 6 | | Corporation) | | | | |
| Organic-inorganic | 110 | LUDOX ® TM-50 (manufactured by Sigma- | 20 | 12 | 110 | 1.7 |
| composite particle 7 | | Aldrich) | | | | |
| Organic-inorganic | 110 | ST-30L (manufactured by Nissan Chemical | 45 | 28 | 115 | 1.7 |
| composite particle 8 | | Corporation) | | | | |
| Organic-inorganic | 110 | ST-YL (manufactured by Nissan Chemical | 60 | 40 | 118 | 1.7 |
| composite particle 9 | | Corporation) | | | | |
| Organic-inorganic | 110 | ST-YL (manufactured by Nissan Chemical | 60 | 44 | 120 | 1.7 |
| composite particle 10 | | Corporation) | | | | |
| Organic-inorganic | 350 | LUDOX ® TM-50 (manufactured by Sigma- | 20 | 9 | 105 | 1.4 |
| composite particle 11 | | Aldrich) | | | | |
| Organic-inorganic | 350 | ST-30L (manufactured by Nissan Chemical | 45 | 20 | 107 | 1.4 |
| composite particle 12 | | Corporation) | | | | |
| Organic-inorganic | 350 | ST-YL (manufactured by Nissan Chemical | 60 | 32 | 110 | 1.4 |
| composite particle 13 | | Corporation) | | | | |
| Organic-inorganic | 350 | ST-YL (manufactured by Nissan Chemical | 60 | 42 | 115 | 1.4 |
| composite particle 14 | | Corporation) | | | | |
| Organic-inorganic | 400 | LUDOX ® TM-50 (manufactured by Sigma- | 20 | 8 | 103 | 1.4 |
| composite particle 15 | | Aldrich) | | | | |
| Organic-inorganic | 400 | ST-YL (manufactured by Nissan Chemical | 45 | 19 | 105 | 1.4 |
| composite particle 16 | | Corporation) | | | | |
| Organic-inorganic | 400 | ST-YL (manufactured by Nissan Chemical | 60 | 28 | 108 | 1.4 |
| composite particle 17 | | Corporation) | | | | |
| Organic-inorganic | 80 | LUDOX ® TM-50 (manufactured by Sigma- | 20 | 13 | 115 | 1.7 |
| composite particle 18 | | Aldrich) | | | | |
| Organic-inorganic | 80 | ST-30L (manufactured by Nissan Chemical | 45 | 28 | 120 | 1.7 |
| composite particle 19 | | Corporation) | | | | |
| Organic-inorganic | 70 | LUDOX ® TM-50 (manufactured by Sigma- | 20 | 13 | 125 | 1.8 |
| composite particle 20 | | Aldrich) | | | | |
| Organic-inorganic | 450 | ST-30L (manufactured by Nissan Chemical | 45 | 18 | 108 | 1.4 |
| composite particle 21 | | Corporation) | | | | |
| Organic-inorganic | 350 | LUDOX ® HS-40 (manufactured by Sigma- | 14 | 7 | 102 | 1.4 |
| composite particle 22 | | Aldrich) | | | | |
| Organic-inorganic | 350 | ST-ZL (manufactured by Nissan Chemical | 80 | 40 | 115 | 1.4 |
| composite particle 23 | | Corporation) | | | | |
| Organic-inorganic | 500 | ST-30L (manufactured by Nissan Chemical | 45 | 15 | 115 | 1.7 |
| composite particle 24 | | Corporation) | | | | |
| Silica-polymer | 144 | LUDOX ® AS-40 (manufactured by Sigma- | 25 | 12 | 110 | 1.7 |
| composite particle 1 | | Aldrich) | | | | |

<To prepare coating liquid 1 for surface layer>
Organic-inorganic composite particle 1:0.67 parts
Silica particle with a particle diameter of 30 nm (QSG-30, manufactured by Shin-Etsu Chemical Co., Ltd.) as a particle other than the organic-inorganic composite particle: 1.64 parts
Monomer 1 having a polymerizable functional group (structural formula (2-1) above): 0.73 parts
Monomer 2 having a polymerizable functional group (structural formula (3-1) above): 0.73 parts
1-Propanol: 40.0 parts
Cyclohexane: 40.0 parts
   were mixed and stirred with a stirrer for 6 hours to prepare a coating liquid 1 for the surface layer.
   <To prepare coating liquids 2 to 51 for surface layer>

The coating liquids 2 to 51 for the surface layer were prepared in the same manner as in the preparation of the coating liquid 1 for the surface layer, except that the kinds and the addition amounts of the organic-inorganic composite particle, the particle other than the organic-inorganic composite particle, and the binder resin were changed to those in Table 2.

<To Measure Physical Properties of Particle (Second Particle) Other than Organic-Inorganic Composite Particle>

### <Number-Average Primary Particle Diameter of Second Particle>

The number average particle diameter of the second particle is measured using a Zetasizer Nano-ZS (manufactured by MALVERN). The Zetasizer can measure a particle diameter by dynamic light scattering. First, an analyte sample is prepared by dilution so that the solid-liquid ratio is 0.10 mass % (+0.02 mass %), and is then collected in a quartz cell and placed in a measuring section. The dispersing medium used is water or a methyl ethyl ketone/methanol mixed solvent when the sample is an inorganic particle, and is water when the sample is a resin particle or an external additive for toner. The refractive index of the sample, the refractive index of the dispersing solvent, the viscosity, and the temperature are input and measured under measurement conditions by using the control software Zetasizersoftware 6.30. Dn is adopted as the average primary particle diameter on a number basis.

The refractive index of the particle is taken from the “Refractive index of solid” listed on page 517 of Volume II of the Chemistry Handbook, Fundamentals, Revised 4th Edition (edited by the Chemical Society of Japan, Maruzen). Regarding the refractive index of the resin particle, the refractive index included in the control software mentioned above is employed as the refractive index of the resin used for the resin particle. However, if there is no built-in refractive index, the value given in the polymer database of the National Institute for Materials Science is used. The refractive index, viscosity and temperature of the dispersing solvent are selected from the values included in the control software mentioned above. In the case of a mixed solvent, the weight average of the dispersing media mixed is adopted.

In addition, the number-average primary particle diameter of the second particle may also be measured directly from the electrophotographic photosensitive member in the following directions.

Specifically, pieces of samples cut out from the surface layer are cut using an ultrasonic ultramicrotome (EM5, manufactured by Leica) to a thickness of 60 to 200 nm to prepare thin samples. The thinned samples are observed using a transmission electron microscope (JEM2800, manufactured by JEOL Ltd.) in the scanning image mode, and STEM images of 100 organic-inorganic composite particles are taken at magnifications of 200,000× to 1,200,000×. The maximum diameters of the second particle in the obtained STEM images may be measured, and the number average diameter may be calculated based on them to determine the primary particle diameter of the conductive microparticle.

TABLE 2

| | | | Particle other than organic- | | | | |
|---|---|---|---|---|---|---|---|
| | | | inorganic composite particle | | | | |
| | | | | | Number- | | |
| | Organic-inorganic | | | | average | | |
| | composite particle | | | | primary | Binder resin | |
| | | Blending | | Blending | particle | | Blending |
| | | amount | | amount | diameter/ | | amount |
| | Kind | [parts] | Kind | [parts] | nm | Kind | [parts] |
| Coating liquid 1 | Organic-inorganic | 0.67 | QSG-30 (Shin-Etsu | 1.64 | 30 | (2-1)/(3-1) | 1.47 |
| for surface layer | composite particle 1 | | Chemical Co., Ltd.) | | | | |
| Coating liquid 2 | Organic-inorganic | 0.67 | QSG-30 (Shin-Etsu | 1.64 | 30 | (3-6) | 1.47 |
| for surface layer | composite particle 1 | | Chemical Co., Ltd.) | | | | |
| Coating liquid 3 | Organic-inorganic | 0.67 | QSG-30 (Shin-Etsu | 1.64 | 30 | (3-6) | 1.47 |
| for surface layer | composite particle 2 | | Chemical Co., Ltd.) | | | | |
| Coating liquid 4 | Organic-inorganic | 0.67 | QSG-30 (Shin-Etsu | 1.64 | 30 | (3-6) | 1.47 |
| for surface layer | composite particle 3 | | Chemical Co., Ltd.) | | | | |
| Coating liquid 5 | Organic-inorganic | 0.61 | QSG-80 (Shin-Etsu | 1.64 | 80 | (3-6) | 1.47 |
| for surface layer | composite particle 4 | | Chemical Co., Ltd.) | | | | |
| Coating liquid 6 | Organic-inorganic | 0.61 | QSG-80 (Shin-Etsu | 1.64 | 80 | (3-6) | 1.47 |
| for surface layer | composite particle 5 | | Chemical Co., Ltd.) | | | | |
| Coating liquid 7 | Organic-inorganic | 0.61 | QSG-80 (Shin-Etsu | 1.64 | 80 | (3-6) | 1.47 |
| for surface layer | composite particle 6 | | Chemical Co., Ltd.) | | | | |
| Coating liquid 8 | Organic-inorganic | 0.68 | QSG-30 (Shin-Etsu | 1.64 | 30 | (3-6) | 1.47 |
| for surface layer | composite particle 7 | | Chemical Co., Ltd.) | | | | |
| Coating liquid 9 | Organic-inorganic | 0.68 | QSG-30 (Shin-Etsu | 1.64 | 30 | (3-6) | 1.47 |
| for surface layer | composite particle 8 | | Chemical Co., Ltd.) | | | | |
| Coating liquid 10 | Organic-inorganic | 0.68 | QSG-30 (Shin-Etsu | 1.64 | 30 | (3-6) | 1.47 |
| for surface layer | composite particle 9 | | Chemical Co., Ltd.) | | | | |
| Coating liquid 11 | Organic-inorganic | 0.68 | QSG-30 (Shin-Etsu | 1.64 | 30 | (3-6) | 1.47 |
| for surface layer | composite particle 10 | | Chemical Co., Ltd.) | | | | |
| Coating liquid 12 | Organic-inorganic | 0.57 | QSG-100 (Shin-Etsu | 1.64 | 110 | (3-6) | 1.47 |
| for surface layer | composite particle 11 | | Chemical Co., Ltd.) | | | | |
| Coating liquid 13 | Organic-inorganic | 0.57 | QSG-100 (Shin-Etsu | 1.64 | 110 | (3-6) | 1.47 |
| for surface layer | composite particle 12 | | Chemical Co., Ltd.) | | | | |
| Coating liquid 14 | Organic-inorganic | 0.57 | QSG-100 (Shin-Etsu | 1.64 | 110 | (3-6) | 1.47 |
| for surface layer | composite particle 13 | | Chemical Co., Ltd.) | | | | |
| Coating liquid 15 | Organic-inorganic | 0.57 | QSG-100 (Shin-Etsu | 1.64 | 110 | (3-6) | 1.47 |
| for surface layer | composite particle 14 | | Chemical Co., Ltd.) | | | | |
| Coating liquid 16 | Organic-inorganic | 0.56 | QSG-100 (Shin-Etsu | 1.64 | 110 | (3-6) | 1.47 |
| for surface layer | composite particle 15 | | Chemical Co., Ltd.) | | | | |
| Coating liquid 17 | Organic-inorganic | 0.56 | QSG-100 (Shin-Etsu | 1.64 | 110 | (3-6) | 1.47 |
| for surface layer | composite particle 16 | | Chemical Co., Ltd.) | | | | |
| Coating liquid 18 | Organic-inorganic | 0.56 | QSG-100 (Shin-Etsu | 1.64 | 110 | (3-6) | 1.47 |
| for surface layer | composite particle 17 | | Chemical Co., Ltd.) | | | | |
| Coating liquid 19 | Organic-inorganic | 0.69 | QSG-30 (Shin-Etsu | 1.64 | 30 | (3-6) | 1.47 |
| for surface layer | composite particle 18 | | Chemical Co., Ltd.) | | | | |
| Coating liquid 20 | Organic-inorganic | 0.69 | QSG-30 (Shin-Etsu | 1.64 | 30 | (3-6) | 1.47 |
| for surface layer | composite particle 19 | | Chemical Co., Ltd.) | | | | |
| Coating liquid 21 | Organic-inorganic | 0.27 | QSG-100 (Shin-Etsu | 0.81 | 110 | (3-6) | 1.47 |
| for surface layer | composite particle 21 | | Chemical Co., Ltd.) | | | | |
| Coating liquid 22 | Organic-inorganic | 0.34 | QSG-100 (Shin-Etsu | 0.81 | 110 | (3-6) | 1.47 |
| for surface layer | composite particle 24 | | Chemical Co., Ltd.) | | | | |
| Coating liquid 23 | Organic-inorganic | 0.25 | QSG-100 (Shin-Etsu | 0.70 | 110 | (3-6) | 1.47 |
| for surface layer | composite particle 12 | | Chemical Co., Ltd.) | | | | |
| Coating liquid 24 | Organic-inorganic | 0.28 | QSG-100 (Shin-Etsu | 0.81 | 110 | (3-6) | 1.47 |
| for surface layer | composite particle 12 | | Chemical Co., Ltd.) | | | | |
| Coating liquid 25 | Organic-inorganic | 0.74 | QSG-80 (Shin-Etsu | 2.01 | 80 | (3-6) | 1.80 |
| for surface layer | composite particle 5 | | Chemical Co., Ltd.) | | | | |
| Coating liquid 26 | Organic-inorganic | 0.50 | QSG-80 (Shin-Etsu | 1.36 | 80 | (3-6) | 1.22 |
| for surface layer | composite particle 5 | | Chemical Co., Ltd.) | | | | |
| Coating liquid 27 | Organic-inorganic | 0.40 | QSG-80 (Shin-Etsu | 1.09 | 80 | (3-6) | 0.97 |
| for surface layer | composite particle 5 | | Chemical Co., Ltd.) | | | | |
| Coating liquid 28 | Organic-inorganic | 0.30 | QSG-80 (Shin-Etsu | 0.81 | 80 | (3-6) | 0.73 |
| for surface layer | composite particle 5 | | Chemical Co., Ltd.) | | | | |
| Coating liquid 29 | Organic-inorganic | 0.27 | QSG-80 (Shin-Etsu | 0.72 | 80 | (3-6) | 0.65 |
| for surface layer | composite particle 5 | | Chemical Co., Ltd.) | | | | |
| Coating liquid 30 | Organic-inorganic | 0.61 | QSG-170 (Shin-Etsu | 1.64 | 170 | (3-6) | 1.47 |
| for surface layer | composite particle 5 | | Chemical Co., Ltd.) | | | | |
| Coating liquid 31 | Organic-inorganic | 0.61 | SIAN120 (EM Japan Co., | 1.64 | 120 | (3-6) | 1.47 |
| for surface layer | composite particle 5 | | LTD.) | | | | |
| Coating liquid 32 | Organic-inorganic | 0.61 | QSG-100 (Shin-Etsu | 1.64 | 100 | (3-6) | 1.47 |
| for surface layer | composite particle 5 | | Chemical Co., Ltd.) | | | | |
| Coating liquid 33 | Organic-inorganic | 0.61 | SIAN50 (EM Japan Co., | 1.64 | 50 | (3-6) | 1.47 |
| for surface layer | composite particle 5 | | LTD.) | | | | |
| Coating liquid 34 | Organic-inorganic | 0.61 | QSG-30 (Shin-Etsu | 1.64 | 30 | (3-6) | 1.47 |
| for surface layer | composite particle 5 | | Chemical Co., Ltd.) | | | | |
| Coating liquid 35 | Organic-inorganic | 0.37 | QSG-80 (Shin-Etsu | 1.96 | 80 | (3-6) | 1.47 |
| for surface layer | composite particle 5 | | Chemical Co., Ltd.) | | | | |
| Coating liquid 36 | Organic-inorganic | 0.46 | QSG-80 (Shin-Etsu | 1.83 | 80 | (3-6) | 1.47 |
| for surface layer | composite particle 5 | | Chemical Co., Ltd.) | | | | |
| Coating liquid 37 | Organic-inorganic | 0.74 | QSG-80 (Shin-Etsu | 1.47 | 80 | (3-6) | 1.47 |
| for surface layer | composite particle 5 | | Chemical Co., Ltd.) | | | | |
| Coating liquid 38 | Organic-inorganic | 0.92 | QSG-80 (Shin-Etsu | 1.22 | 80 | (3-6) | 1.47 |
| for surface layer | composite particle 5 | | Chemical Co., Ltd.) | | | | |
| Coating liquid 39 | Organic-inorganic | 1.01 | QSG-80 (Shin-Etsu | 1.10 | 80 | (3-6) | 1.47 |
| for surface layer | composite particle 5 | | Chemical Co., Ltd.) | | | | |
| Coating liquid 40 | Organic-inorganic | 1.75 | QSG-80 (Shin-Etsu | 0.12 | 80 | (3-6) | 1.47 |
| for surface layer | composite particle 5 | | Chemical Co., Ltd.) | | | | |
| Coating liquid 41 | Organic-inorganic | 1.84 | — | — | — | (3-6) | 1.47 |
| for surface layer | composite particle 5 | | | | | | |
| Coating liquid 42 | Organic-inorganic | 0.26 | QSG-80 (Shin-Etsu | 0.70 | 80 | (3-6) | 1.47 |
| for surface layer | composite particle 5 | | Chemical Co., Ltd.) | | | | |
| Coating liquid 43 | Organic-inorganic | 0.30 | QSG-80 (Shin-Etsu | 0.81 | 80 | (3-6) | 1.47 |
| for surface layer | composite particle 5 | | Chemical Co., Ltd.) | | | | |
| Coating liquid 44 | Organic-inorganic | 0.40 | QSG-80 (Shin-Etsu | 1.0916 | 80 | (3-6) | 1.47 |
| for surface layer | composite particle 5 | | Chemical Co., Ltd.) | | | | |
| Coating liquid 45 | Organic-inorganic | 0.91 | QSG-80 (Shin-Etsu | 2.4562 | 80 | (3-6) | 1.47 |
| for surface layer | composite particle 5 | | Chemical Co., Ltd.) | | | | |
| Coating liquid 46 | Organic-inorganic | 1.42 | QSG-80 (Shin-Etsu | 3.8208 | 80 | (3-6) | 1.47 |
| for surface layer | composite particle 5 | | Chemical Co., Ltd.) | | | | |
| Coating liquid 47 | Organic-inorganic | 1.82 | QSG-80 (Shin-Etsu | 4.9124 | 80 | (3-6) | 1.47 |
| for surface layer | composite particle 5 | | Chemical Co., Ltd.) | | | | |
| Coating liquid 48 | Organic-inorganic | 0.57 | QSG-100 (Shin-Etsu | 1.6375 | 110 | (3-6) | 1.47 |
| for surface layer | composite particle 22 | | Chemical Co., Ltd.) | | | | |
| Coating liquid 49 | Organic-inorganic | 0.57 | QSG-100 (Shin-Etsu | 1.6375 | 110 | (3-6) | 1.47 |
| for surface layer | composite particle 23 | | Chemical Co., Ltd.) | | | | |
| Coating liquid 50 | Organic-inorganic | 1.41 | QSG-100 (Shin-Etsu | 4.2106 | 110 | (3-6) | 1.47 |
| for surface layer | composite particle 21 | | Chemical Co., Ltd.) | | | | |
| Coating liquid 51 | Organic-inorganic | 1.66 | QSG-101 (Shin-Etsu | 3.8208 | 30 | (3-7) | 1.47 |
| for surface layer | composite particle 20 | | Chemical Co., Ltd.) | | | | |
| Coating liquid 52 | Silica-polymer | 63 | — | — | — | Polycarbonate | 375 |
| for surface layer | composite particle 1 | | | | | | |

### <To Produce Electrophotographic Photosensitive Member>

The following method was used to produce a support, a conductive layer, an undercoat layer, a charge generation layer, a charge transport layer, and a surface layer. [Electrophotographic photosensitive member 1]

### <Support>

An aluminum cylinder with a diameter of 24 mm and a length of 257 mm was used as the support (cylindrical support).

### <Conductive Layer>

The coating liquid 1 for the conductive layer was applied onto the above-mentioned support by dipping to form a coating film, and the coating film was cured by heating at 150° C. for 30 minutes to form a conductive layer with a film thickness of 22 μm.

<Undercoat layer>

The coating liquid 1 for the undercoat layer was applied onto the above-mentioned conductive layer by dipping to form a coating film, and the coating film was cured by heating at 100° C. for 10 minutes to form an undercoat layer with a film thickness of 1.8 μm.

### <Charge Generation Layer>

The coating liquid 1 for the charge generation layer was applied onto the above-mentioned undercoat layer by dipping to form a coating film, and the coating film was heated and dried at a temperature of 100° C. for 10 minutes to form a charge generation layer with a film thickness of 0.20 μm.

### <Charge Transport Layer>

The coating liquid 1 for the charge transport layer was applied onto the above-mentioned charge generation layer by dipping to form a coating film, and the coating film was heated and dried at a temperature of 120° C. for 30 minutes to form a charge transport layer with a film thickness of 21 μm.

### <Surface Layer>

The coating liquid 1 for the surface layer was applied onto the above-mentioned charge transport layer by dipping to form a coating film, and the coating film was heated at a temperature of 50° C. for 5 minutes. The support (irradiated object) was then irradiated with electron beams for 2.0 seconds in a nitrogen atmosphere, while the support was rotated at a speed of 300 rpm, under conditions at an acceleration voltage of 65 kV and a beam current of 5.0 mA. The dose was 15 kGy. The temperature of the coating film was then raised to 120° C. under a nitrogen atmosphere. The oxygen level from the electron bean irradiation to the subsequent heat treatment was 10 ppm.

Next, the coating film was cooled naturally in air until the temperature reached 25° C., and then heated for 30 minutes under conditions, in which the temperature of the coating film reached 120° C., to form a surface layer with a film thickness of 0.5 μm.

The respective physical property values of the obtained electrophotographic photosensitive member 1 were calculated. The results are shown in Table 3.

### <Electrophotographic Photosensitive Members 2 to 51>

Electrophotographic photosensitive members 2 to 51 were produced using the coating liquids 2 to 51 for the surface layer in the same manner as in the production of electrophotographic photosensitive member 1, except that in the production of the electrophotographic photosensitive member 1, the coating solution 1 for the surface layer was changed according to the conditions in Table 2. Table 3 shows the physical properties of each of the obtained electrophotographic photosensitive members.

### <Electrophotographic Photosensitive Member 52>

The electrophotographic photosensitive member 52 was produced in the same manner as in the production of the electrophotographic photosensitive member 1, except that the charge transport layer was prepared by the method below and the charge transport layer was used as the surface layer in the production of the electrophotographic photosensitive member 1. Table 3 shows the physical properties of each of the obtained electrophotographic photosensitive members.

### [Charge Transport Layer]

A silica-polymer composite particle as the organic-inorganic composite particle was prepared by the following method using colloidal silica (number-average primary particle diameter: 25 nm; manufactured by Sigma-Aldrich; trade name: LUDOX (registered trademark) AS-40) as based on the description of Example 1 of International Publication No. WO2013/063291.

To a 250-mL four-necked round-bottom flask equipped with an overhead stirring motor, a condenser, and a thermocouple, 18.7 g of LUDOX AS-40 colloidal silica dispersion (W.R. Grace & Co.) (particle diameter: 20 to 30 nm; BET surface area: 126 m²/g; pH 9.1; silica concentration: 40 mass %), 125 mL of DI water, and 16.5 g (0.066 moles) of methacryloxypropyl-trimethoxysilane (Gelest, Inc.; further abbreviated as MPS; CAS #2530-85-0; Mw=248.3) were added. In this Example, the mass ratio MPS/silica was 2.2. The temperature was increased to 65° C., and the mixture was stirred at 120 rpm. Nitrogen gas was bubbled through this mixture for 30 minutes. After 3 hours, 0.16 g (about 1 mass % of MPS) of 2,2′-azobisisobutyronitrile (further abbreviated as AIBN; CAS #78-67-1; Mw=164.2) radical initiator, which had been dissolved in 10 mL of ethanol, was added, and the temperature was increased to 75° C. The radical polymerization was allowed to proceed for 5 hours, after which 3 mL of 1,1,1,3,3,3-hexamethyldisilazane (HMDZ) was added to the mixture. The reaction was allowed to proceed for another 3 hours. The final mixture was filtered through a 170-mesh sieve to remove coagulated materials, and the dispersion was dried overnight at 120° C. in a Pyrex (registered trademark) dish to prepare a silica-polymer composite particle 1.

Next, 63 g of the resulting silica-polymer composite particle 1 (number-average primary particle diameter: 145 nm), 250 g of N,N′-diphenyl-N,N′-di(m-tolyl)benzidine (manufactured by Tokyo Chemical Industry Co., Ltd.; product code: D2448), and 375 g of polycarbonate (trade name: TS2050, manufactured by Teijin Chemicals Ltd.) were added to 2725 g of tetrahydrofuran. The materials were mixed, and stirred in a ball mill for 15 hours. The resulting mixture was processed by 1-Pass dispersion while using a particle dispersion apparatus (Model: M-110P, manufactured by Microfluidics LLC) to prepare a coating liquid 52 for the surface layer. The resulting coating liquid 52 for the surface layer was applied onto the charge generation layer by the same dipping process as in the case of forming the undercoat layer, and the resulting coating film was dried at 120° C. for 1 hour to form a surface layer with a film thickness of 30 μm.

### <To Measure Physical Properties of Electrophotographic Photosensitive Member>

### <Height of Large Convexity>

Pieces of samples cut out from an electrophotographic photosensitive member were cut using an ultrasonic ultramicrotome (EM5, manufactured by Leica) to a thickness of 60 to 200 nm to prepare thin samples. The thinned samples were observed using a transmission electron microscope (JEM2800, manufactured by JEOL Ltd.) in the scanning image mode, and STEM images of 30 organic-inorganic composite particles at the top surface were taken at a magnification ranging from 200,000× to 1,200,000×.

Each obtained STEM image is used to calculate the center of gravity 601 of the organic-inorganic composite particle as shown in FIG. 7, and determine the circle 701 that has the largest radius circumscribed by a surface with the circumference point 702, which surface is in the range of L/2 with respect to the width L of the organic-inorganic composite particle in the direction parallel to the surface while the center of gravity 601 is used as the center. The points where the circumference circle 701 intersected the surface profile were defined as C and D. The maximum distance between the line segment CD and the surface within the width L was measured.

In addition, when there were more than two intersections between the circumference circle 701 and the surface profile, C and D were determined such that the length of the line segment CD was maximized. When the circle 701 in contact with the surface profile was unable to be determined, the height of large convexity was set to 0.

Thinned samples were prepared from 3 points including the top, middle, and bottom of the electrophotographic photosensitive member, and 30 organic-inorganic composite particles in each thinned sample were measured and averaged to calculate the height of large convexity. The results are shown in Table 3.

### <Curvature Radius/Height of Small Convexity B)

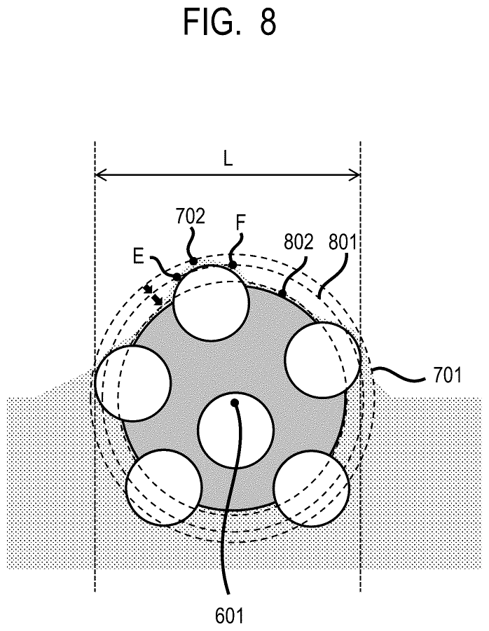

In the STEM image where the height of large convexity was determined, as shown in FIG. 8, the circle 701 in contact with the surface is continuously decreased in radius while the center used was the center of gravity 601 of the organic-inorganic composite particle. As a result, the circumference point 702 is divided into the points E and F where the circle 801 intersects the surface and moves continuously as the radius decreases. Further, when the radius is continuously decreased and the point E or F is not a point of intersection between the surface and the circle anymore but is a point of contact for the first time, the circle 802 is set. The difference between the radii of circles 701 and 802 was measured and used as the height of small convexity B.

In addition, the curvature radius was determined as follows.

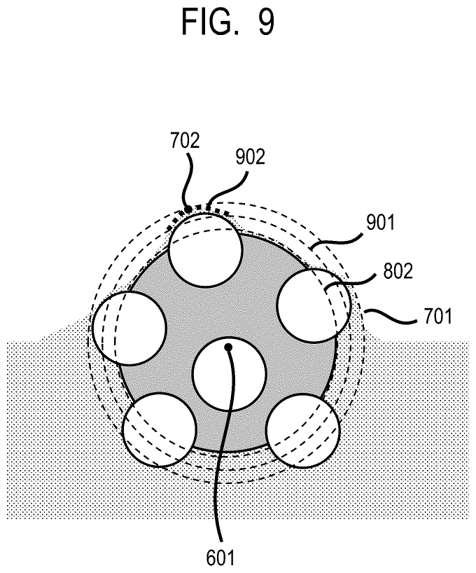

In the above STEM image, as shown in FIG. 9, the center of gravity 601 of the organic-inorganic composite particle is used as a center to determine the circle 901 with the average radius calculated using the radius of circle 701 and the radius of circle 802. The surface 902, which is sandwiched between the circle 701 and the circle 901 and includes the circumference point 702, is approximated by a circular arc while using the least-squares method. The radius of the approximated arc was set to the curvature radius of small convexity B.

Thinned samples were prepared from 3 points including the top, middle, and bottom of the electrophotographic photosensitive member, and 30 organic-inorganic composite particles in each thinned sample were measured and averaged to calculate the curvature of small convexity B. The results are shown in Table 3.

### <Presence or Absence of Small Convexity B Exposed>

Platinum deposition was performed on each sample piece cut out from an electrophotographic photosensitive member. A cross-section of the surface layer was then inspected by FIB-SEM. Based on the difference in contrast of Slice & View of FIB-SEM, the presence or absence of small convexity B exposed was determined by whether or not the resin could be seen between the platinum and the small convexity B. In the observation area, the case where the number of small convexities B exposed was 90% or more was graded as A; the case where the number of small convexities B exposed was 50% or more and less than 90% was graded as B; the case where the number of small convexities B exposed was 10% or more and less than 50% was graded as C; and the case where the number of small convexities B exposed was less than 10% was graded as D. The results are shown in Table 3.
The Slice & View conditions were as follows.
Analyte processing: FIB method
Processing and observation apparatus: SII/Zeiss available NVision40
Slice spacing: 10 nm

### (Observation Conditions)

Acceleration voltage: 1.0 kV
Sample inclination: 54 degrees
WD: 5 mm
Detector: BSE detector
Aperture: 60 μm, high current
ABC: ON
Image resolution: 1.25 nm/pixel

The analysis area is 2 μm (length)×2 μm (width), and the volume V per 2 μm (length)×2 μm (width)×2 μm (thickness) (8 μm³) is obtained by integrating the information for each cross section. In addition, the measurement environment was the temperature: 23° C. and the pressure: 1×10⁻⁴ Pa.

### <To Calculate Percentage of Volume of Organic-Inorganic Composite Particle and Second Particle to Total Volume of Surface Layer>

The percentage of the volume of particles to the total volume of the surface layer was calculated from the amount of monomer with a polymerizable functional group and particles added to and used in the coating liquid for the surface layer, the density, and the true specific gravity. The specific gravity of the polymerized product and particles after polymerization of the monomer with a polymerizable functional group can be referred to the published values from the manufacturer of each material or in the National Institute for Materials Science database POLYINFO.

In the case of obtaining the values from the electrophotographic photosensitive member, the following procedure, for instance, is used.

A cross-section of the electrophotographic photosensitive member produced in each Example was observed. Samples for cross-sectional observation were taken by dividing the photosensitive member into four equal parts in the longitudinal direction at ¼, ½, and ¾ distances from the edge while displaced by 120 degrees in the circumferential direction. Sample pieces of 5-mm square were cut out from each photosensitive member, and the surface layer was three-dimensionally constructed at 2 μm×2 μm×2 μm by the Slice & View of FIB-SEM.

The Slice & View conditions were as follows.
Analyte processing: FIB method
Processing and observation apparatus: SII/Zeiss available NVision40
Slice spacing: 5 nm

### (Observation Conditions)

Acceleration voltage: 1.0 kV
Sample inclination: 54 degrees
WD: 5 mm
Detector: BSE detector
Aperture: 60 μm, high current
ABC: ON
Image resolution: 1.25 nm/pixel

In addition, the measurement environment was the temperature: 23° C. and the pressure: 1×10⁻⁴ Pa. The Strata400S (sample inclination: 52 degrees) manufactured by FEI may be used as the processing and observation apparatus.

The analysis area is 2 μm (length)×2 μm (width), and the information for each cross-section is integrated to determine the volume V per 2 μm (length)×2 μm (width)×2 μm (thickness) (8 μm³) at the surface of the surface layer. In addition, each cross sectional image was analyzed using Image-Pro Plus, as image processing software, manufactured by Media Cybernetics.

The particle content in the total volume of the surface layer was calculated from the difference in contrast of the Slice & View of FIB-SEM. Based on the information obtained from the image analysis, the volume V of the particle of the present invention in terms of a volume of 2 μm ×2 μm ×2 μm (unit volume: 8 μm³) was determined for each of the four sample pieces, and the particle content [vol %] (=V μm³/8 μm³×100) was calculated. The values for the particle content in each sample piece were averaged to determine the content [vol %] of each particle of the present invention in the surface layer based on the total volume of the surface layer.

### <How to Measure Particle Coverage S1/(S1+S2) on Surface of Surface Layer of Electrophotographic Photosensitive Member>

In the electrophotographic photosensitive member of the present invention, when the surface layer is viewed from the top, the area of the particle is set to S1, and the total area other than the particle is set to S2, the coverage S1/(S1+S2) can be calculated as follows. In the present invention, a scanning electron microscope (SEM) is used to observe the surface of the surface layer of the electrophotographic photosensitive member of the present invention from the top surface under settings at an acceleration voltage of 5 kV or higher. The area of particle found in the electron reflection image of the surface layer is added to S1 if the image of particle can be confirmed.

The surface of the surface layer of the electrophotographic photosensitive member was photographed using a scanning electron microscope (SEM) (“S-4800”, manufactured by JEOL Ltd.) at an acceleration voltage of 5 kV. Photographic images of the surface layer of the photosensitive member were scanned at 30000× for a total of 12 sites obtained by 3 locations including positions 50 mm from each end and at the middle of the electrophotographic photosensitive member in the longitudinal direction for 4 locations while positioned by 90 degrees each in the circumferential direction. The particles in each photographic image were binarized using an image processing and analysis apparatus (“LUZEX AP”, manufactured by NIRECO CORPORATION).

The area of the particle is set to S1 and the total of area other than the particle is set to S2 to calculate the coverage S1/(S1+S2) (%). The above-described coverage was calculated for a total of 10 fields of view. The coverages obtained were averaged and then used as the coverage of the particle on the surface layer of the photosensitive member.

TABLE 3

| | | Height of | Small convexity B | | | Large convexity |
|---|---|---|---|---|---|---|
| | Electrophotographic | large | Curvature | | Presence or | height/Small |
| Example | photosensitive member | convexity | radius | Height | absence of | convexity B |
| No. | No. | [nm] | [nm] | [nm] | exposure | curvature radius |
| Example 1 | Electrophotographic | 115 | 11 | 11 | A | 10.5 |
| | photosensitive member 1 | | | | | |
| Example 2 | Electrophotographic | 115 | 11 | 11 | A | 10.5 |
| | photosensitive member 2 | | | | | |
| Example 3 | Electrophotographic | 115 | 23 | 26 | A | 5.0 |
| | photosensitive member 3 | | | | | |
| Example 4 | Electrophotographic | 115 | 30 | 36 | A | 3.8 |
| | photosensitive member 4 | | | | | |
| Example 5 | Electrophotographic | 170 | 10 | 10 | A | 17.0 |
| | photosensitive member 5 | | | | | |
| Example 6 | Electrophotographic | 170 | 23 | 20 | A | 7.4 |
| | photosensitive member 6 | | | | | |
| Example 7 | Electrophotographic | 170 | 30 | 33 | A | 5.7 |
| | photosensitive member 7 | | | | | |
| Example 8 | Electrophotographic | 80 | 10 | 12 | A | 8.0 |
| | photosensitive member 8 | | | | | |
| Example 9 | Electrophotographic | 80 | 23 | 28 | A | 3.5 |
| | photosensitive member 9 | | | | | |
| Example 10 | Electrophotographic | 80 | 30 | 40 | A | 2.7 |
| | photosensitive member 10 | | | | | |
| Example 11 | Electrophotographic | 80 | 30 | 44 | A | 2.7 |
| | photosensitive member 11 | | | | | |
| Example 12 | Electrophotographic | 220 | 10 | 9 | A | 22.0 |
| | photosensitive member 12 | | | | | |
| Example 13 | Electrophotographic | 220 | 23 | 20 | A | 9.8 |
| | photosensitive member 13 | | | | | |
| Example 14 | Electrophotographic | 220 | 30 | 32 | A | 7.3 |
| | photosensitive member 14 | | | | | |
| Example 15 | Electrophotographic | 220 | 30 | 42 | A | 7.3 |
| | photosensitive member 15 | | | | | |
| Example 16 | Electrophotographic | 250 | 10 | 8 | A | 25.0 |
| | photosensitive member 16 | | | | | |
| Example 17 | Electrophotographic | 250 | 23 | 19 | A | 11.1 |
| | photosensitive member 17 | | | | | |
| Example 18 | Electrophotographic | 250 | 30 | 28 | A | 8.3 |
| | photosensitive member 18 | | | | | |
| Example 19 | Electrophotographic | 70 | 10 | 13 | A | 7.0 |
| | photosensitive member 19 | | | | | |
| Example 20 | Electrophotographic | 70 | 23 | 28 | A | 3.0 |
| | photosensitive member 20 | | | | | |
| Example 21 | Electrophotographic | 218 | 20 | 15 | B | 10.9 |
| | photosensitive member 21 | | | | | |
| Example 22 | Electrophotographic | 0 | 15 | 10 | C | 0.0 |
| | photosensitive member 22 | | | | | |
| Example 23 | Electrophotographic | 155 | 20 | 15 | B | 7.8 |
| | photosensitive member 23 | | | | | |
| Example 24 | Electrophotographic | 141 | 15 | 10 | C | 9.4 |
| | photosensitive member 24 | | | | | |
| Example 25 | Electrophotographic | 150 | 23 | 20 | A | 6.5 |
| | photosensitive member 25 | | | | | |
| Example 26 | Electrophotographic | 180 | 23 | 20 | A | 7.8 |
| | photosensitive member 26 | | | | | |
| Example 27 | Electrophotographic | 190 | 23 | 20 | A | 8.3 |
| | photosensitive member 27 | | | | | |
| Example 28 | Electrophotographic | 200 | 23 | 20 | A | 8.7 |
| | photosensitive member 28 | | | | | |
| Example 29 | Electrophotographic | 220 | 23 | 20 | A | 9.6 |
| | photosensitive member 29 | | | | | |
| Example 30 | Electrophotographic | 70 | 23 | 20 | A | 3.0 |
| | photosensitive member 30 | | | | | |
| Example 31 | Electrophotographic | 120 | 23 | 20 | A | 5.2 |
| | photosensitive member 31 | | | | | |
| Example 32 | Electrophotographic | 150 | 23 | 20 | A | 6.5 |
| | photosensitive member 32 | | | | | |
| Example 33 | Electrophotographic | 195 | 23 | 20 | A | 8.5 |
| | photosensitive member 33 | | | | | |
| Example 34 | Electrophotographic | 210 | 23 | 20 | A | 9.1 |
| | photosensitive member 34 | | | | | |
| Example 35 | Electrophotographic | 170 | 23 | 20 | A | 7.4 |
| | photosensitive member 35 | | | | | |
| Example 36 | Electrophotographic | 170 | 23 | 20 | A | 7.4 |
| | photosensitive member 36 | | | | | |
| Example 37 | Electrophotographic | 170 | 23 | 20 | A | 7.4 |
| | photosensitive member 37 | | | | | |
| Example 38 | Electrophotographic | 170 | 23 | 20 | A | 7.4 |
| | photosensitive member 38 | | | | | |
| Example 39 | Electrophotographic | 160 | 23 | 20 | A | 7.0 |
| | photosensitive member 39 | | | | | |
| Example 40 | Electrophotographic | 100 | 23 | 20 | A | 4.3 |
| | photosensitive member 40 | | | | | |
| Example 41 | Electrophotographic | 70 | 23 | 20 | A | 3.0 |
| | photosensitive member 41 | | | | | |
| Example 42 | Electrophotographic | 98 | 15 | 10 | C | 6.5 |
| | photosensitive member 42 | | | | | |
| Example 43 | Electrophotographic | 110 | 20 | 15 | B | 5.5 |
| | photosensitive member 43 | | | | | |
| Example 44 | Electrophotographic | 138 | 21 | 19 | A | 6.6 |
| | photosensitive member 44 | | | | | |
| Example 45 | Electrophotographic | 170 | 23 | 20 | A | 7.4 |
| | photosensitive member 45 | | | | | |
| Example 46 | Electrophotographic | 180 | 23 | 20 | A | 7.8 |
| | photosensitive member 46 | | | | | |
| Example 47 | Electrophotographic | 190 | 23 | 20 | A | 8.3 |
| | photosensitive member 47 | | | | | |
| Comparative | Electrophotographic | 200 | 7 | 5 | A | 28.6 |
| Example 1 | photosensitive member 48 | | | | | |
| Comparative | Electrophotographic | 200 | 40 | 40 | A | 5.0 |
| Example 2 | photosensitive member 49 | | | | | |
| Comparative | Electrophotographic | 280 | 23 | 15 | A | 12.2 |
| Example 3 | photosensitive member 50 | | | | | |
| Comparative | Electrophotographic | 60 | 10 | 13 | A | 6.0 |
| Example 4 | photosensitive member 51 | | | | | |
| Comparative | Electrophotographic | 3 | 13 | 3 | D | 0.2 |
| Example 5 | photosensitive member 52 | | | | | |

| | Organic-inorganic | | Volume- | Percentage of | | | | | | |
|---|---|---|---|---|---|---|---|---|---|---|
| | composite particle | | average | organic- | | | Transfer performance | | | |
| | Volume- | | particle | inorganic | | | Initial | | After endured | |
| | average | | diameter | composite | | | Residual | | Residual | |
| | particle | Shape | [nm] of | particle to the | Particle | | density | | density | |
| Example | diameter | factor | second | previous | content | Coverage | after | | after | |
| No. | [nm] | SF-2 | particle | particle | [volume %] | [%]. | transfer | Rank | transfer | Rank |
| Example 1 | 144 | 109 | 30 | 33% | 50 | 85% | 2.0 | B | 2.7 | B |
| Example 2 | 144 | 109 | 30 | 33% | 50 | 85% | 2.5 | B | 3.3 | B |
| Example 3 | 144 | 112 | 30 | 33% | 50 | 85% | 1.2 | A | 1.6 | A |
| Example 4 | 144 | 115 | 30 | 33% | 50 | 85% | 2.7 | B | 2.9 | B |
| Example 5 | 250 | 105 | 80 | 33% | 50 | 85% | 1.8 | A | 2.3 | B |
| Example 6 | 250 | 107 | 80 | 33% | 50 | 85% | 0.9 | A | 1.2 | A |
| Example 7 | 250 | 111 | 80 | 33% | 50 | 85% | 1.9 | A | 2.2 | B |
| Example 8 | 110 | 110 | 30 | 33% | 50 | 85% | 3.5 | B | 4.5 | C |
| Example 9 | 110 | 115 | 30 | 33% | 50 | 85% | 2.5 | B | 3.0 | B |
| Example 10 | 110 | 118 | 30 | 33% | 50 | 85% | 3.8 | B | 4.0 | C |
| Example 11 | 110 | 120 | 30 | 33% | 50 | 85% | 4.2 | C | 4.5 | C |
| Example 12 | 350 | 105 | 110 | 33% | 50 | 85% | 3.5 | B | 4.2 | C |
| Example 13 | 350 | 107 | 110 | 33% | 50 | 85% | 2.8 | B | 3.0 | B |
| Example 14 | 350 | 110 | 110 | 33% | 50 | 85% | 3.6 | B | 3.9 | B |
| Example 15 | 350 | 115 | 110 | 33% | 50 | 85% | 3.6 | B | 4.2 | C |
| Example 16 | 400 | 103 | 110 | 33% | 50 | 85% | 4.5 | C | 4.9 | C |
| Example 17 | 400 | 105 | 110 | 33% | 50 | 85% | 3.3 | B | 3.6 | B |
| Example 18 | 400 | 108 | 110 | 33% | 50 | 85% | 3.2 | B | 3.5 | B |
| Example 19 | 100 | 115 | 30 | 33% | 50 | 85% | 4.3 | C | 4.5 | C |
| Example 20 | 100 | 120 | 30 | 33% | 50 | 85% | 3.3 | B | 3.6 | B |
| Example 21 | 450 | 108 | 110 | 33% | 33 | 85% | 2.8 | B | 3.1 | B |
| Example 22 | 500 | 107 | 110 | 33% | 33 | 85% | 3.5 | B | 3.6 | B |
| Example 23 | 350 | 107 | 110 | 33% | 30 | 85% | 2.2 | B | 2.4 | B |
| Example 24 | 350 | 107 | 110 | 33% | 33 | 85% | 2.6 | B | 2.8 | B |
| Example 25 | 250 | 107 | 80 | 33% | 50 | 95% | 1.1 | A | 1.3 | A |
| Example 26 | 250 | 107 | 80 | 33% | 50 | 80% | 1.0 | A | 1.3 | A |
| Example 27 | 250 | 107 | 80 | 33% | 50 | 75% | 1.2 | A | 1.4 | A |
| Example 28 | 250 | 107 | 80 | 33% | 50 | 70% | 1.3 | A | 1.6 | A |
| Example 29 | 250 | 107 | 80 | 33% | 50 | 68% | 1.8 | A | 2.0 | A |
| Example 30 | 250 | 107 | 170 | 33% | 50 | 85% | 2.5 | B | 2.8 | B |
| Example 31 | 250 | 107 | 120 | 33% | 50 | 85% | 1.9 | A | 2.2 | B |
| Example 32 | 250 | 107 | 100 | 33% | 50 | 85% | 1.3 | A | 1.6 | A |
| Example 33 | 250 | 107 | 50 | 33% | 50 | 85% | 1.2 | A | 1.4 | A |
| Example 34 | 250 | 107 | 30 | 33% | 50 | 85% | 2.0 | B | 2.2 | B |
| Example 35 | 250 | 107 | 80 | 20% | 50 | 85% | 0.9 | A | 1.1 | A |
| Example 36 | 250 | 107 | 80 | 25% | 50 | 85% | 0.9 | A | 1.1 | A |
| Example 37 | 250 | 107 | 80 | 40% | 50 | 85% | 1.0 | A | 1.2 | A |
| Example 38 | 250 | 107 | 80 | 50% | 50 | 85% | 1.3 | A | 1.5 | A |
| Example 39 | 250 | 107 | 80 | 55% | 50 | 85% | 2.0 | A | 2.2 | B |
| Example 40 | 250 | 107 | 80 | 95% | 50 | 85% | 3.8 | B | 4.1 | C |
| Example 41 | 250 | 107 | — | 100% | 50 | 85% | 4.2 | C | 4.6 | C |
| Example 42 | 250 | 107 | 80 | 33% | 30 | 85% | 2.3 | B | 3.0 | B |
| Example 43 | 250 | 107 | 80 | 33% | 33 | 85% | 1.7 | A | 2.0 | B |
| Example 44 | 250 | 107 | 80 | 33% | 40 | 85% | 1.1 | A | 1.3 | A |
| Example 45 | 250 | 107 | 80 | 33% | 60 | 85% | 1.0 | A | 1.3 | A |
| Example 46 | 250 | 107 | 80 | 33% | 70 | 85% | 0.9 | A | 1.5 | A |
| Example 47 | 250 | 107 | 80 | 33% | 75 | 85% | 0.9 | A | 2.2 | B |
| Comparative | 350 | 102 | 110 | 33% | 50 | 85% | 9.0 | D | 9.8 | D |
| Example 1 | | | | | | | | | | |
| Comparative | 350 | 115 | 110 | 33% | 50 | 85% | 8.3 | D | 8.7 | D |
| Example 2 | | | | | | | | | | |
| Comparative | 450 | 108 | 110 | 33% | 72 | 85% | 8.1 | D | 8.5 | D |
| Example 3 | | | | | | | | | | |
| Comparative | 80 | 125 | 30 | 33% | 70 | 85% | 4.8 | C | 8.2 | D |
| Example 4 | | | | | | | | | | |
| Comparative | 144 | 110 | — | 100% | 7 | 13% | 22.0 | D | 25.0 | D |
| Example 5 | | | | | | | | | | |

### <Production Examples of Toner Particle 1>

### (To Prepare Aqueous Medium 1)

To a reaction vessel equipped with a stirrer, a thermometer, and a reflux tube, 650.0 parts of ion-exchanged water and 14.0 parts of sodium phosphate (dodecahydrate, manufactured by Rasa Industries, Ltd.) were added, and the vessel was kept at 65° C. for 1.0 hour with nitrogen purging.

An aqueous medium containing a dispersion stabilizer was prepared by batch feeding an aqueous calcium chloride solution containing 9.2 parts of calcium chloride (dihydrate) dissolved in 10.0 parts of ion exchanged water while stirring at 15,000 rpm by using a T.K. homomixer (manufactured by Tokushu Kika Kogyo Co., Ltd.). Further, 10 mass % hydrochloric acid was added to the aqueous medium, and the pH was adjusted to 5.0 to obtain an aqueous medium 1.

### (to Prepare Polymerizable Monomer Composition)

Styrene: 60.0 parts by mass
C.I. Pigment Blue 15:3: 6.5 parts by mass

The above materials were fed into an attritor (manufactured by MITSUI MIIKE CHEMICAL MACHINERY COMPANY, LIMITED) and further dispersed with zirconia particles having a diameter of 1.7 mm at 220 rpm for 5.0 hours, after which the zirconia particles were removed to prepare a colorant dispersion solution.

Meanwhile,
Styrene: 20.0 parts by mass
n-Butyl acrylate: 20.0 parts by mass
Cross-linking agent (divinylbenzene): 0.3 parts by mass
Saturated polyester resin: 5.0 parts by mass
   (product obtained by polycondensing propylene oxide-modified bisphenol A (2-mole adduct) and terephthalic acid (molar ratio 10:12); glass transition temperature (Tg): 68° C.; weight-average molecular weight (Mw): 10000; molecular weight distribution (Mw/Mn): 5.12)
Fischer-Tropsch wax (melting point 78° C.): 7.0 parts by mass

The above materials were added to the above colorant dispersion solution. The mixture was heated to 65° C., and uniformly dissolved and dispersed at 500 rpm by using a T.K. homomixer (manufactured by Tokushu Kika Kogyo Co., Ltd.) to prepare a polymerizable monomer composition.

### (Granulation Step)

The temperature of aqueous medium 1 was adjusted to 70° C., the rotation speed of the T.K. homomixer was kept at 15,000 rpm, the polymerizable monomer composition was fed into the aqueous medium 1, and 10.0 parts by mass of t-butylperoxypivalate, a polymerization initiator, was added. The granulation was performed for 10 minutes while the stirrer was maintained at 15,000 rpm.

(Polymerization step and distillation step)

After the granulation step, the stirrer was changed to a propeller agitator with blades and the polymerization was carried out by holding the temperature at 70° C. for 5.0 hours while stirring at 150 rpm, and the polymerization was further carried out by increasing the temperature to 85° C. and holding the temperature for 2.0 hours. The reflux tube of the reaction vessel was replaced with a cooling tube, and the resulting slurry was heated to 100° C. over 6 hours for distillation to remove the unreacted polymerizable monomer. In this way, a toner particle dispersion 1 was thus obtained.

(Filtration step, washing step, drying step, and classification step)

Hydrochloric acid was added to the obtained toner particle dispersion 1, the pH was set to 1.4 or less, and the above-described dispersion stabilizer was dissolved. The mixture was filtered, washed, dried, and classified to produce a toner particle 1. The number-average particle diameter (D1) and the weight-average particle diameter (D4) of the toner particle 1 were 6.2 μm and 6.7 μm, respectively.

### <Production Example of Toner 1>

First, 100.0 parts by mass of the resulting toner particle 1 and 1.0 part by mass of silica particle (subjected to hydrophobic treatment with hexamethyldisilazane; number-average particle diameter of primary particle: 8 nm; BET specific surface area: 160 m²/g) were mixed in a Henschel mixer (manufactured by MITSUI MIIKE CHEMICAL MACHINERY COMPANY, LIMITED). The resulting mixture was sieved through a mesh with a mesh aperture of 75 μm to prepare toner 1.

### <Evaluation Method>

### <To Evaluate Transfer Performance>

The Examples and Comparative Examples were evaluated using the following evaluation method.

A modified commercially available Canon laser beam printer i-SENSYS LBP 673 Cdw was used. Regarding the modification points, modifications were made to the main body of the evaluation apparatus and the software so that the applied bias during the transfer step can be changed.

The toner from the cyan toner cartridge of the evaluation apparatus should be removed and the required amount of toner 1 should be loaded. The cyan toner cartridge was left in a normal temperature and humidity environment (25° C. and 50% RH; hereinafter also referred to as N/N) for 24 hours. The toner cartridge left in the normal temperature and humidity environment for 24 hours was installed in the above evaluation apparatus. Under the N/N environment, up to 500 images at a print area of 5.0% were printed out in the center portion horizontally on A4 paper with a margin of 50 mm on the left and right sides.

For evaluation, solid images were output at the initial stage of use (after printing the first sheet) and after printing 1000 sheets (after endured). The residual toner after transfer on the electrophotographic photosensitive member during solid image formation was stripped off and collected by taping with an adhesive transparent tape made of transparent polyester (polyester tape 5511; Nichiban).

The following technique was used to measure the density of the residual toner after transfer. The transparent tape, by which the residual toner after transfer was collected, as removed from the surface of an electrophotographic photosensitive member and a new transparent tape were each placed on a piece of high white paper (GFC081; Canon). Then, the density D1 in the post-transfer residual toner collection area of the transparent tape and the density DO of the new transparent tape were measured with a reflection densitometer (Reflectometer; model TC-6DS; manufactured by Tokyo Denshoku Co., Ltd.) while the filter was set to an amber filter, which gives a color complementary to cyan. The difference “DO-D1” obtained from the measurement was used as the density of the residual toner after transfer. This means that the lower the value for the density of the residual toner after transfer, the less the toner after transfer remains. The determination was as follows. The obtained post-transfer residual density was ranked in 5 ranks from A to D based on the following criteria. Of the rankings, A to C were considered to exert the effect of the present invention. The evaluation results are shown in Table 3.

### (Evaluation Criteria)

A: Residual density after transfer is less than 2.0
B: Residual density after transfer is 2.0 or more and less than 4.0
C: Residual density after transfer is 4.0 or more and less than 8.0
D: Residual density after transfer is 8.0 or more

According to the present invention, the area of contact between the toner and the electrophotographic photosensitive member can be reduced. As a result, an electrophotographic photosensitive member with favorable transfer performance can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An electrophotographic photosensitive member having a surface layer comprising a binder resin and a particle,
the particle being an organic-inorganic composite particle,
the organic-inorganic composite particle comprising
a resin particle and
an inorganic microparticle partially embedded in the resin particle, wherein
a surface of the organic-inorganic composite particle has a small convexity A derived from the inorganic microparticle,
a surface of the surface layer has a large convexity derived from the organic-inorganic composite particle,
the large convexity has a height of 70 nm or more and 250 nm or less,
a surface of the large convexity has a small convexity B derived from the small convexity A, and
the small convexity B has a curvature radius of 10 nm or more and 30 nm or less.

2. The electrophotographic photosensitive member according to claim 1, wherein the small convexity B has a height of 10 nm or more and 40 nm or less.

3. The electrophotographic photosensitive member according to claim 1, wherein the height of the large convexity is 3.0 times or more and 10.0 times or less the curvature radius of the small convexity B.

4. The electrophotographic photosensitive member according to claim 1, wherein the organic-inorganic composite particle has a number-average primary particle diameter of 100 nm or more and 400 nm or less.

5. The electrophotographic photosensitive member according to claim 1,
wherein the surface layer comprises a particle other than the organic-inorganic composite particle, and
wherein the ratio of the organic-inorganic composite particle and the particle other than the organic-inorganic composite particle to a total volume of the surface layer is 33 vol % or more and 70 vol % or less.

6. The electrophotographic photosensitive member according to claim 1, wherein the inorganic microparticle is exposed on a surface of the small convexity B.

7. The electrophotographic photosensitive member according to claim 1, wherein the organic-inorganic composite particle has a shape factor SF-2 of 103 or more and 120 or less.

8. The electrophotographic photosensitive member according to claim 5,
wherein the particle other than the organic-inorganic composite particle is an inorganic particle, and
wherein the inorganic particle has a number-average primary particle diameter that is ⅕ or more and ½ or less of a number-average primary particle diameter of the organic-inorganic composite particle.

9. A process cartridge integrally supporting at least one unit selected from the group consisting of charging units, developing units, and cleaning units, and being detachable from a main body of an electrophotographic apparatus, wherein
the process cartridge comprises an electrophotographic photosensitive member,
the electrophotographic photosensitive member has a surface layer comprising a binder resin and a particle, the particle being an organic-inorganic composite particle,
the organic-inorganic composite particle comprising
a resin particle and
an inorganic microparticle partially embedded in the resin particle, wherein
a surface of the organic-inorganic composite particle has a small convexity A derived from the inorganic microparticle,
a surface of the surface layer has a large convexity derived from the organic-inorganic composite particle,
the large convexity has a height of 70 nm or more and 250 nm or less,
a surface of the large convexity has a small convexity B derived from the small convexity A, and
the small convexity B has a curvature radius of 10 nm or more and 30 nm or less.

10. An electrophotographic apparatus comprising an electrophotographic photosensitive member, a charging unit, an exposure unit, a developing unit, and a transfer unit, wherein
the electrophotographic photosensitive member has a surface layer comprising a binder resin and a particle, the particle being an organic-inorganic composite particle,
the organic-inorganic composite particle comprising
a resin particle and
an inorganic microparticle partially embedded in the resin particle, wherein
a surface of the organic-inorganic composite particle has a small convexity A derived from the inorganic microparticle,
a surface of the surface layer has a large convexity derived from the organic-inorganic composite particle,
the large convexity has a height of 70 nm or more and 250 nm or less,
a surface of the large convexity has a small convexity B derived from the small convexity A, and
the small convexity B has a curvature radius of 10 nm or more and 30 nm or less.
